(19) United States
(12) Patent Application Publication
(10) Pub. No.: US 2011/0283739 A1
(43) Pub. Date: Nov. 24, 2011

(54) METHOD FOR MANUFACTURING GLASS BLANK, METHOD FOR MANUFACTURING MAGNETIC RECORDING MEDIUM SUBSTRATE AND METHOD FOR MANUFACTURING MAGNETIC RECORDING MEDIUM

(75) Inventors: Makoto OSAWA, Tokyo (JP); Akira MURAKAMI, Tokyo (JP); Nobuhiro SUGIYAMA, Tokyo (JP); Takashi SATOU, Tokyo (JP); Hideki ISONO, Tokyo (JP); Kinobu OSAKABE, Tokyo (JP); Hidekazu TANINO, Tokyo (JP); Takao MOTOHASHI, Tokyo (JP)

(73) Assignee: HOYA CORPORATION, Tokyo (JP)

(21) Appl. No.: 13/071,212

(22) Filed: Mar. 24, 2011

(30) Foreign Application Priority Data
Mar. 31, 2010 (JP) 2010-083725
Oct. 1, 2010 (JP) 2010-224029

(51) Int. Cl. C03B 7/14; C03B 11/05; C03B 7/10; C03C 17/00

(52) U.S. Cl. 65/60.1; 65/66; 65/97

(57) ABSTRACT

Provided are a method of manufacturing a glass blank, the method including press-molding a molten glass gob under a state in which a separation mark formed on an upper surface of the molten glass gob faces at least one of the molding surface sides of a pair of press molds arranged facing each other in a horizontal direction, when the molten glass gob falls into a space between the pair of press molds, and a method of manufacturing a magnetic recording medium substrate and a method of manufacturing a magnetic recording medium, both using the glass blank.

### CROSS-REFERENCE TO RELATED APPLICATIONS

The present application claims priority from Japanese Patent Application No. 2010-083725 filed on Mar. 31, 2010 and Japanese Patent Application No. 2010-224029 filed on Oct. 1, 2010, the entirety of which is hereby incorporated by reference into this application.

### BACKGROUND

1. Technical Field

The present invention relates to a method of manufacturing a glass blank, a method of manufacturing a magnetic recording medium substrate, and a method of manufacturing a magnetic recording medium.

2. Background Art

As a method of manufacturing a magnetic recording medium substrate (magnetic disk substrate), there are typically exemplified (1) a method of manufacturing a substrate through a press-molding step of subjecting a molten glass gob to press-molding with a pair of press molds (hereinafter, sometimes referred to as “press method”. See Patent Literature 1 or the like), and (2) a method of manufacturing a substrate through a processing step of cutting, into a disk shape, a sheet-shaped glass formed by a float method, a down-draw method, or the like (hereinafter, sometimes referred to as “sheet-shaped glass-cutting method.” See Patent Literature 2 or the like).

In conventional sheet-shaped glass-cutting methods exemplified in Patent Literature 2 and the like, a magnetic recording medium substrate was obtained by carrying out a disk processing step of processing a sheet-shaped glass into a disk shape and then carrying out, as polish steps, a lapping step (rough-polishing treatment) and a polishing step (precision-polishing treatment). However, it is disclosed that, in the sheet-shaped glass-cutting method shown in Patent Literature 2, the lapping step (rough-polishing treatment) is eliminated and only the polishing step (precision-polishing treatment) is carried out as a polish step.

On the other hand, in conventional press methods exemplified in Patent Literature 1 and the like, a magnetic recording medium substrate is usually obtained by carrying out a press-molding step with a method of press-molding a molten glass gob, in which the molten glass gob is placed in a lower mold and a pressing pressure is then applied to the molten glass gob from the vertical direction by using an upper mold and the lower mold (hereinafter, sometimes referred to as “vertical direct press”), and then carrying out a lapping step and a polishing step.

In addition, it is proposed that, in the press method shown in Patent Literature 1, the press-molding step is carried out with a method in which a pressing pressure is applied to a molten glass gob from the horizontal direction by using a pair of press molds arranged so as to face each other in the horizontal direction (hereinafter, sometimes referred to as “horizontal direct press”). Further, Patent Literature 1 discloses the following four respects as advantages and disadvantages for the case of employing the horizontal direct press: (1) there is a difficult aspect that a pair of press molds must be moved at a high speed; (2) a molten glass gob can be subjected to press-molding under a state in which its temperature is high; (3) a thinner glass substrate precursor (glass blank) can be obtained; and (4) a polish step can be diminished or eliminated. However, Patent Literature 1 does not disclose what kind of polish step can be diminished or eliminated.

Further, when the press-molding step exemplified in Patent Literature 1 or the like is carried out, a molten glass gob that is subjected to press-molding is usually formed by cutting the forward end portion of a molten glass flow falling downward in the vertical direction by causing a pair of shear blades to cross the molten glass flow. Thus, a separation mark produced by the contact with the shear blades is formed in the surface of the molten glass gob. As a result, when a glass blank for a magnetic recording medium substrate is manufactured with vertical direct press, there finally remain, in both surfaces of the glass blank, an irregular portion (which may be referred to as “shear mark”) such as a minute line, a groove, or an air bubble derived from the separation mark. Thus, it is proposed that a recessed portion is provided in the central portion of the molding surface of a lower mold in order to reduce a polishing allowance of a glass blank having such shear mark, thereby, for example, improving the productivity of a magnetic recording medium substrate (see Patent Literature 3).

### CITATION LIST

### Patent Literature

[Patent Literature 1] JP 4380379 B (paragraph 0031, FIG. 1 to FIG. 9, and the like)

[Patent Literature 2] JP 2003-36528 A (FIG. 3 to FIG. 6, FIG. 8, and the like)

[Patent Literature 3] JP 2001-192216 A (claim 1, paragraphs 0002 to 0007, FIG. 1, and the like)

### SUMMARY

On the other hand, from the viewpoint of enhancing the productivity of a magnetic recording medium substrate, it is very effective to eliminate a lapping step or to carry out a lapping step in a shorter time, the lapping step being carried out mainly for the purposes of securing the flatness and uniformity in thickness of the magnetic recording medium substrate, adjusting its thickness, and the like. This is because, carrying out the lapping step requires a lapping apparatus, and hence man-hours for manufacturing a magnetic recording medium substrate become larger and the processing time thereof increases. Further, the lapping step may cause the occurrence of cracks in the surfaces of glass. Thus, the present situation is that examination is being made on how to eliminate the lapping step. Here, when the sheet-shaped glass-cutting method and the press method are compared from the viewpoint of eliminating the lapping step, more advantageous is the sheet-shaped glass-cutting method, in which processing is carried out by using a sheet-shaped glass having a higher flatness manufactured by a float method, a down-draw method, or the like. However, the press method has the advantage that glass is used more efficiently compared with the sheet-shaped glass-cutting method.

In order to eliminate a lapping step or to carry out a lapping step in a shorter time at the time of manufacturing a substrate for a magnetic recording medium by applying post-processing to a glass blank manufactured by using vertical direct press, it is necessary to make the thickness deviation of the glass blank smaller and to improve the flatness thereof. This is because the process for producing the magnetic recording medium substrate from the glass blank does not include a step of adjusting the flatness of a glass plate after the lapping step, and hence a glass blank having the same level of flatness as that required for the magnetic recording medium substrate must be prepared to eliminate the lapping step. Here, when a glass blank is produced by vertical direct press, the temperature of a lower mold is set to a temperature sufficiently lower than the temperature of a high-temperature molten glass gob in order to prevent the molten glass gob from melting and bonding to the lower mold. Thus, during the period from placing the molten glass gob on the lower mold until starting press-molding, the molten glass gob loses heat through the surface being in contact with the lower mold, and hence the viscosity of the lower surface of the molten glass gob placed on the lower mold locally increases. As a result, the press-molding is carried out to the molten glass gob having a wide viscosity distribution (temperature distribution), producing portions that resist stretching by press. Besides, a cooling speed after the press-molding is different for each site in a glass molded body produced by stretching glass by press-molding so as to have a plate shape. Consequently, a glass blank that is manufactured by using vertical direct press is liable to have an increased thickness deviation or to have a deteriorated flatness.

Thus, in order to eliminate a lapping step or to carry out a lapping step in a shorter time at the time of producing a magnetic recording medium substrate by a press method, it is recommended to make the viscosity distribution of a molten glass gob uniform immediately prior to the start of press-molding. In order to achieve the goal, it is recommended to separate the forward end portion of a molten glass flow flowing out downward in the vertical direction from a glass outlet, thereby forming a molten glass gob, and to perform press-molding to a falling molten glass gob by horizontal direct press. In this case, the molten glass gob is temporarily not brought into contact with and not held by a member having a temperature lower than that of the molten glass gob, such as a lower mold, during the period until the molten glass gob is subjected to press-molding, and hence the viscosity distribution of the molten glass gob is kept uniform immediately prior to the start of press-molding. Therefore, in the case where a glass blank is manufactured by using horizontal direct press, it is extremely easy to fundamentally suppress the increase of the thickness deviation and the reduction of the flatness, compared with the case where a glass blank is manufactured by using vertical direct press. Thus, if attention is paid only to this respect, it seems likely that eliminating a lapping step or carrying out a lapping step in a shorter time can be easily realized.

However, although a shear mark remains in the vicinity of the central portion of the glass blank that is manufactured by using vertical direct press, a shear mark remains at a position away from the vicinity of the central portion of the glass blank that is manufactured by using horizontal direct press. Further, when a glass blank is processed into a magnetic recording medium substrate, a shear mark remaining at a position away from the vicinity of the central portion of the glass blank may have a chance of remaining at a position serving as the main surface of the magnetic recording medium substrate, even after a central hole-forming step of forming a central hole is carried out. Thus, even if the thickness deviation and flatness of the glass blank are immensely improved by employing horizontal direct press, it becomes difficult to eliminate a lapping step or to carry out a lapping step in a shorter time because the shear mark must be removed.

A first aspect of the present invention has been made in view of the above-mentioned circumstances, and has an object to provide a method of manufacturing a glass blank in which a shear mark is localized in the vicinity of the central portion of a glass blank when the glass blank is manufactured by using horizontal direct press, a method of manufacturing a magnetic recording medium substrate and a method of manufacturing a magnetic recording medium using the method of manufacturing a glass blank.

Further, a second aspect of the present invention has been made to solve the above-mentioned problems, and has an object to provide a method of manufacturing a glass blank for manufacturing, by press-molding molten glass, a glass blank for a magnetic recording medium substrate, the glass blank having a small thickness deviation, having a good flatness, and enabling a shear mark to be removed while central-hole forming processing is being performed, a method of manufacturing a magnetic recording medium substrate, in which a glass blank manufactured by the method described above is processed into a magnetic recording medium substrate without carrying out a lapping step, and a method of manufacturing a magnetic recording medium by using a substrate manufactured by the method described above.

The inventors of the present invention have intensively studied in order to solve the above-mentioned problems which the first aspect of the present invention targets. As a result, the inventors have found the findings described below. First, cutting a molten glass flow forms a separation mark at an upper portion of a molten glass gob and at the lower end of the molten glass flow, and the separation mark at the lower end of the molten glass flow is heated by surrounding high-temperature glass, thereby disappearing by the time of the next cutting. However, the separation mark formed at the upper portion of the molten glass gob does not disappear but remains as it is, and hence the separation mark formed at the upper portion of the molten glass gob causes a shear mark to occur in a glass blank. In view of the foregoing, the inventors of the present invention have made studies on what causes a shear mark to remain at a position away from the vicinity of the central portion of the glass blank that is manufactured by using horizontal direct press, by taking images of a falling molten glass gob with a high-speed camera and replaying the taken images slowly.

First, a molten glass gob comes in contact with molding surfaces of press molds, loses heat to the molding surfaces, and is solidified so as to attach to the molding surfaces. Then, glass with low viscosity inside the molten glass gob is spread by pressing into the space sandwiched by a pair of the molding surfaces. Here, when the molten glass gob falls without changing its direction at the time of its cutting, a separation mark is eventually positioned at an upper portion of the molten glass gob at the time of the start of the press. Then, if the molten glass gob is pressed as it is, the separation mark should be pushed out to an outer edge of a flat glass obtained by press-molding so as to have a thin plate shape. However, the molten glass gob was actually press-molded into a flat glass in which a separation mark was positioned in a main surface excluding the region of the vicinity of the central portion. That is probably the reason why a shear mark remains at a position serving as the main surface of a magnetic recording medium substrate in the glass blank manufactured by using horizontal direct press. Note that the reason why the separation mark moves to the above-mentioned position is estimated that the glass with low viscosity inside the molten glass gob pushes the separation mark out to molding surface sides.

Thus, in order for the shear mark remaining in the glass blank to be present in the region which is removed in a central hole-forming step carried out at the time of manufacturing a magnetic recording medium substrate, it is necessary for the separation mark present in the surface of the molten glass gob to be able to come, at the time of press-molding, into contact with the molding surfaces of the press molds substantially earlier than any other portions of the surface of the molten glass gob. In this case, the molten glass gob can be stretched isotropically by press-molding around the separation mark present in the surface of the molten glass gob. Consequently, a shear mark can be caused to remain in the vicinity of the central portion of the glass blank. Thus, it is not necessary to provide a large amount of a grinding allowance and/or a polishing allowance in order to remove a shear mark, and eliminating a lapping step or carrying out a lapping step in a shorter time can be realized.

The first aspect of the present invention has been made in view of the findings described above. That is, a method of manufacturing a glass blank according to the first aspect of the present invention includes at least: forming a molten glass gob by separating a forward end portion of a molten glass flow flowing out continuously; and after the forming of the molten glass gob, press-molding the molten glass gob dropping down with a first press mold and a second press mold arranged facing each other in a direction crossing a direction in which the molten glass gob drops down, in which: the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface; and one sheet of the glass blank is used for production of one sheet of a magnetic recording medium substrate having a central hole.

In one embodiment of the method of manufacturing a glass blank according to the first aspect of the present invention, it is preferred that: the forming of the molten glass gob be carried out by separating a forward end portion of a molten glass flow flowing out continuously toward a vertical downward direction; and the press-molding include carrying out applying an external force to at least one glass material to be press-molded selected from: (1) the forward end portion of the molten glass flow to be separated as the molten glass gob during the forming of the molten glass gob; and (2) the molten glass gob dropping down in a period just after completion of the forming of the molten glass gob to just before start of the press-molding, from a direction crossing a vertical direction so that a vector sum of forces acting in a direction perpendicular to a central axis of the glass material to be press-molded parallel to the vertical direction substantially exceeds 0, in order to rotate the molten glass gob so that the molten glass gob can be brought into contact with at least one molding surface selected from the molding surface of the first press mold and the molding surface of the second press mold facing a separation mark, which is formed on an upper surface of the molten glass gob during the separating of the forward end portion of the molten glass flow, under a state in which the separation mark faces the at least one molding surface.

In another embodiment of the method of manufacturing a glass blank according to the first aspect of the present invention, it is preferred that: a cross-section near the forward end portion of the molten glass flow in a plane surface perpendicular to a direction in which the molten glass flow drops down have a substantially elliptical shape having a major axis and a minor axis; and the separating of the forward end portion of the molten glass flow be carried out by allowing a pair of shear blades to penetrate the molten glass flow from a direction substantially perpendicular to the direction in which the molten glass flow drops down and substantially identical to a major axis direction of the cross-section near the forward end portion of the molten glass flow and from a direction opposite each other and crossing a vertical direction.

In another embodiment of the method of manufacturing a glass blank according to the first aspect of the present invention, it is preferred that: the separating of the forward end portion of the molten glass flow be carried out by allowing a pair of shear blades to penetrate the molten glass flow from a direction substantially perpendicular to a direction in which the molten glass flow drops down and from a direction opposite each other and crossing a vertical direction; and a cutting portion of each of the pair of shear blades be branched and have any one shape selected from a V-shape and a U-shape.

In another embodiment of the method of manufacturing a glass blank according to the first aspect of the present invention, it is preferred that the separation mark, which is present on the surface of the molten glass gob just before carrying out the press-molding, be positioned on a straight line connecting a central point of the molten glass gob to any one molding surface selected from the molding surface of the first press mold and the molding surface of the second press mold in a shortest distance.

In another embodiment of the method of manufacturing a glass blank according to the first aspect of the present invention, it is preferred that the press-molding be carried out so that the molten glass gob is completely extended by pressure between the molding surface of the first press mold and the molding surface of the second press mold and be molded into a flat glass, in which at least a region in contact with the flat glass in each of the molding surface of the first press mold and the molding surface of the second press mold form a flat surface.

A method of manufacturing a magnetic recording medium substrate according to the first aspect of the present invention includes: manufacturing a glass blank, including at least: forming a molten glass gob by separating a forward end portion of a molten glass flow flowing out continuously; and after the forming of the molten glass gob, press-molding the molten glass gob dropping down with a first press mold and a second press mold arranged facing each other in a direction crossing a direction in which the molten glass gob drops down; and then manufacturing one sheet of a magnetic recording medium substrate from one sheet of the glass blank, including at least: forming a central hole at a central portion of a main surface of the glass blank; and polishing the main surface, in which the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface.

A method of manufacturing a magnetic recording medium substrate according to the first aspect of the present invention includes: manufacturing a glass blank, including at least: forming a molten glass gob by separating a forward end portion of a molten glass flow flowing out continuously; and after the forming molten glass gob, press-molding the molten glass gob dropping down with a first press mold and a second press mold arranged facing each other in a direction crossing a direction in which the molten glass gob drops down; manufacturing one sheet of a magnetic recording medium substrate from one sheet of the glass blank, including at least: forming a central hole at a central portion of a main surface of the glass blank; and polishing the main surface; and then manufacturing a magnetic recording medium, including at least forming a magnetic recording layer on a main surface of the magnetic recording medium substrate, in which the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface.

A shear blade according to the first aspect of the present invention at least includes a substantially plate-shaped body portion, a blade portion, which is provided at an end portion side of the body portion and cuts the forward end portion of a molten glass flow continuously flowing out downward in the vertical direction from the direction substantially perpendicular to the direction to which the molten glass flow falls down, and a pressing member which is provided at a lower surface side of the body portion, stretches to a blade portion side from a body portion side, and presses the forward end portion in collaboration with the movement that the blade portion approaches to and penetrates into the molten glass flow at the time of cutting the molten glass flow.

One embodiment of the shear blade according to the first aspect of the present invention preferably includes the pressing member which is attachable to and detachable from the body portion and a fitting portion for fitting the pressing member at the lower surface of the body portion.

In addition, the inventors of the present invention have intensively studied in order to solve the above-mentioned problems which the second aspect of the present invention targets. As a result, the inventors have found the findings described below. Cutting a molten glass flow forms a cut mark at an upper portion of a molten glass gob and at the lower end of the molten glass flow, but the cut mark at the lower end of the molten glass flow is heated by surrounding high-temperature glass, thereby disappearing by the time of the next cutting. A shear mark that is a problem derives from the cut mark formed at an upper portion of the molten glass gob.

A high-speed camera is used to take images of an appearance of a falling molten glass gob under being pressed and the taken images are slowly replayed. The images show that glass comes in contact with press-molding surfaces, is loses heat to the press-molding surfaces, and is solidified so as to attach to the press-molding surfaces. Then, glass with low viscosity inside the molten glass gob is spread by pressing into the space sandwiched by the press-molding surfaces.

When the molten glass gob falls without changing its direction, a shear mark is positioned at an upper portion of the molten glass gob at the time of the start of the pressing. When the glass is pressed as it is, the shear mark should be pushed out to an outer edge of a thin flat glass. However, actually, the glass with low viscosity inside the molten glass gob pushes the shear mark to the press-molding surface sides, and the shear mark eventually remains in the main surface of the thin flat glass.

If a shear mark is brought into contact with a press-molding surface at the time of the start of pressing and can be solidified so as to attach to the press-molding surface, it is possible to prevent glass with low viscosity inside a molten glass gob from pushing the shear mark to a position at which the shear mark is out of control. For that purpose, a position at which the shear mark is formed needs to be pressed first.

In addition, glass can be pressed and spread uniformly around the shear mark, and hence the shear mark can be localized in the central portion of a glass blank. A glass blank produced by a method of manufacturing a glass blank described below according to the second aspect of the present invention is processed into a magnetic recording medium having a central hole. Thus, by localizing a shear mark in a region at which the central hole is formed, the shear mark can be simultaneously removed at the time of center-hole forming processing. Consequently, it becomes unnecessary to provide a large amount of a grinding allowance and polishing allowance in order to remove the shear mark from the main surface.

The second aspect of the present invention has been made on the basis of the findings described above in order to solve the above-mentioned problems which the second aspect of the present invention targets. That is,

the method of manufacturing a glass blank according to the second aspect of the present invention includes separating a molten glass gob from a molten glass flow flowing out from a glass outlet, press-molding the molten glass gob into a thin flat glass by using press molds, thereby manufacturing a glass blank to be processed into a magnetic recording medium substrate having a central hole, in which the molten glass gob is separated and falls, and the molten glass gob in the air is pressed with press-molding surfaces facing each other, thereby molding the molten glass gob into the thin flat glass, and the direction of the molten glass gob is changed so that the site at which the molten glass gob is separated from the molten glass flow faces one of the press-molding surfaces, followed by the start of the pressing.

In one embodiment of the method of manufacturing a glass blank according to the second aspect of the present invention, it is preferred that a cross-sectional shape of the molten glass flow be controlled so that its horizontal cross section has a major axis and a minor axis, and that the molten glass flow be cut in the major axis direction by using a shear blade.

In another embodiment of the method of manufacturing a glass blank according to the second aspect of the present invention, it is preferred that cutting blades cut the molten glass flow by causing a pair of V-shaped shear blades or a pair of U-shaped shear blades to cross each other.

In another embodiment of the method of manufacturing a glass blank according to the second aspect of the present invention, it is preferred that the direction of the molten glass gob be changed by applying a torque to the molten glass gob at the time of cutting the molten glass flow.

A method of manufacturing a magnetic recording medium substrate according to the second aspect of the present invention is characterized in that a magnetic recording medium substrate is produced by at least going through a polishing step of polishing the main surface of a glass blank manufactured by the method of manufacturing a glass blank according to the second aspect of the present invention and a hole-forming step of providing a center hole in the center of the main surface.

A method of manufacturing a magnetic recording medium according to the second aspect of the present invention is characterized in that a magnetic recording medium is produced by at least going through a magnetic recording layer-forming step of forming a magnetic recording layer on a magnetic recording medium substrate manufactured by the method of manufacturing a magnetic recording medium substrate according to the second aspect of the present invention.

As described above, the first aspect of the present invention can provide the method of manufacturing a glass blank, in which a shear mark is localized in the vicinity of the central portion of a glass blank when the glass blank is manufactured by using horizontal direct press, the method of manufacturing a magnetic recording medium substrate and the method of manufacturing a magnetic recording medium using the method of manufacturing a glass blank.

Besides, the second aspect of the present invention can provide the method of manufacturing a glass blank for manufacturing, by press-molding molten glass, a glass blank for a magnetic recording medium substrate, the glass blank having a small thickness deviation, having a good flatness, and enabling a shear mark to be removed while central-hole forming processing is being performed. The second aspect of the present invention can also provide the method of manufacturing a magnetic recording medium substrate, in which a glass blank manufactured by the above-mentioned method is processed into a magnetic recording medium substrate without carrying out a lapping step and the method of manufacturing a magnetic recording medium by using a substrate manufactured by the method described above.

### BRIEF DESCRIPTION OF THE DRAWINGS

FIG. 1 is a schematic cross-sectional view illustrating a part of all steps in one example of a method of manufacturing a glass blank in a first embodiment.

FIG. 2 is a schematic cross-sectional view illustrating another part of all steps in the one example of the method of manufacturing a glass blank in the first embodiment.

FIG. 3 is a graph illustrating one example of the vectors of forces acting in an X-axis direction on an upper hemisphere of a glass material to be press-molded.

FIG. 4 is a graph illustrating one example of the vector of a force acting in the X-axis direction on the upper hemisphere of the glass material to be press-molded.

FIG. 5 is a schematic cross-sectional view illustrating one example of a falling molten glass gob.

FIG. 6 is a schematic cross-sectional view illustrating another part of all steps in the one example of the method of manufacturing a glass blank in the first embodiment.

FIG. 7 is a schematic cross-sectional view illustrating another part of all steps in the one example of the method of manufacturing a glass blank in the first embodiment.

FIG. 8 is a schematic cross-sectional view illustrating another part of all steps in the one example of the method of manufacturing a glass blank in the first embodiment.

FIG. 9 is a schematic cross-sectional view illustrating another part of all steps in the one example of the method of manufacturing a glass blank in the first embodiment.

FIG. 10 is a schematic cross-sectional view illustrating another part of all steps in the one example of the method of manufacturing a glass blank in the first embodiment.

FIG. 11 is a schematic cross-sectional view illustrating another part of all steps in the one example of the method of manufacturing a glass blank in the first embodiment.

FIG. 12 is a schematic cross-sectional view illustrating one example of separation of a forward end portion of a molten glass flow with a pair of shear blades.

FIG. 13, which illustrates a method of manufacturing a glass blank in a second embodiment, illustrates how a molten glass flow flowing out from a glass outlet is cut with shear blades, viewed from the horizontal direction.

FIG. 14, which illustrates the method of manufacturing a glass blank in the second embodiment, illustrates how a molten glass gob is separated by cutting the molten glass flow and a force is applied to an upper portion of the molten glass gob from the horizontal direction, thereby changing the direction of the molten glass gob.

FIG. 15, which illustrates the method of manufacturing a glass blank in the second embodiment, illustrates how the separated molten glass gob is falling while turning.

FIG. 16, which illustrates the method of manufacturing a glass blank in the second embodiment, illustrates how the molten glass gob is falling, while turning, to the space between press-molding surfaces facing each other.

FIG. 17, which illustrates the method of manufacturing a glass blank in the second embodiment, is a vertical cross-sectional view of press molds and the molten glass gob illustrating how pressing the molten glass gob starts.

FIG. 18, which illustrates the method of manufacturing a glass blank in the second embodiment, is a vertical cross-sectional view of the press molds and glass illustrating a process in which the glass is pushed and stretched into a thin plate shape by pressing.

FIG. 19, which illustrates the method of manufacturing a glass blank in the second embodiment, illustrates a vertical cross section of the press molds and a thin flat glass at the time of molding glass into the thin flat glass by pressing.

FIG. 20, which illustrates the method of manufacturing a glass blank in the second embodiment, is a vertical cross-sectional view of the press molds and the thin flat glass illustrating how the thin flat glass is cooled while the press-molding surfaces are caused to follow the behavior of the thin flat glass.

FIG. 21, which illustrates the method of manufacturing a glass blank in the second embodiment, is a vertical cross-sectional view illustrating how the thin flat glass is demolded from one of the press-molding surfaces.

FIG. 22, which illustrates the method of manufacturing a glass blank in the second embodiment, illustrates how the thin flat glass is taken out from the press molds.

### DETAILED DESCRIPTION

### First Embodiment

### [Method of Manufacturing Glass Blank]

A method of manufacturing a glass blank according to a first aspect of the present invention includes at least: forming a molten glass gob by separating a forward end portion of a molten glass flow flowing out continuously; and after the forming of the molten glass gob, press-molding the molten glass gob dropping down with a first press mold and a second press mold arranged facing each other in a direction crossing a direction in which the molten glass gob drops down. Here, the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface, and one sheet of the glass blank is used for production of one sheet of a magnetic recording medium substrate having a central hole.

In the method of manufacturing a glass blank in the first embodiment, under a state in which the molten glass gob formed by separating from the molten glass flow falls and reaches the space between the molding surface of the first press mold and the molding surface of the second press mold, the separation mark formed in the surface of the molten glass gob at the time of its separation faces at least one of the molding surface sides. Then, the molten glass gob in that state is press-molded by being pressed with the first press mold and the second press mold. That is, the press-molding step is carried out under a state in which the separation mark causing a shear mark to occur faces at least one of the molding surface sides. As a result, the shear mark remaining in the glass blank is eventually localized in the vicinity of the central portion of the glass blank. In this case, the shear mark is removed together with the central portion (central hole-forming region) of the glass blank because a central hole is formed at the time of manufacturing the magnetic recording medium substrate. Thus, it is not necessary to provide a large amount of a grinding allowance and/or a polishing allowance in order to remove the shear mark, and eliminating a lapping step or carrying out a lapping step in a shorter time can be realized.

Note that only one magnetic recording medium is manufactured from one glass blank produced by the method of manufacturing a glass blank in the first embodiment. In this case, the volume of a molten glass gob to be used for manufacturing one glass blank falls, from the viewpoint of good use efficiency of glass, preferably within the range of two times or less the volume of one magnetic recording medium substrate, more preferably within the range of 1.3 times or less. Note that, for the sake of reference, if a glass blank is supposed to have a disk shape, the diameter of the glass blank is defined as φb, the thickness of the glass blank is defined as tb, and the diameter of a magnetic recording medium substrate is defined as φsub, when the following formula (1) is satisfied, two or more magnetic recording medium substrates cannot be manufactured from one glass blank or one molten glass gob.

φsub×2>φb Formula (1)

On the other hand, the volume Vgob of a molten glass gob equals to the volume of a glass blank, if the change of the volume of glass due to temperature change is disregarded. Specifically, their relationship is represented by the following formula (2).

Vgob=π×(φb/2)²×tb Formula (2)

Thus, when the following formula (3) is satisfied, only one magnetic recording medium substrate can be manufactured from one glass blank having the same volume as one molten glass gob.

Vgob<π×φsub²×tb (3)

Note that the first press mold and the second press mold may be arranged so that the both face each other in the direction which crosses the falling direction of the molten glass gob, and it is usually particularly preferred that the both be arranged so that the both face each other in the direction which is perpendicular to the falling direction of the molten glass gob. The following descriptions are described based on a state in which the first press mold and the second press mold are arranged so that the both face each other in the direction which is perpendicular to the falling direction of the molten glass gob.

Further, the molten glass gob separated from the forward end portion of the molten glass flow may fall down into the space between the first press mold and the second press mold without turning to any extent but with its falling state kept, followed by press-molding. Alternatively, the molten glass gob may fall down into the space between the first press mold and the second press mold after having turned for a moment or while turning, followed by press-molding. Here, in the case when the molten glass gob falls down into the space between the first press mold and the second press mold without turning to any extent but with its falling state kept, a separation mark formed in the surface of the molten glass gob needs to be positioned at a side surface of the molten glass gob at the time when the molten glass gob is separated from the forward end portion of the molten glass flow.

On the other hand, a molten glass gob is usually formed by separating the forward end portion of a molten glass flow continuously flowing out downward in the vertical direction. In this case, a separation mark is formed in an upper surface of the molten glass gob immediately after having been separated from the molten glass flow. In this case, it is necessary to turn the molten glass gob so that, under a state in which the separation mark formed in the upper surface of the molten glass gob at the time of separating the forward end portion of the molten glass flow faces any one molding surface selected from the molding surface of the first press mold and the molding surface of the second press mold, the molten glass gob can be brought into contact with the molding surface facing the separation mark in the press-molding step. For that purpose, it is necessary to carry out an external force-imparting step of imparting an external force, from the direction crossing the vertical direction, to at least one glass material to be press-molded selected from the following glass materials, so that the vector sum of the forces acting in the direction perpendicular to the central axis of the glass material to be press-molded, the central axis being parallel to the vertical direction, substantially exceeds zero: (1) the forward end portion of the molten glass flow separated as the molten glass gob at the time of carrying out the molten glass gob-forming step; and (2) the falling molten glass gob in the period from immediately after the completion of the molten glass gob-forming step until just prior to the start of the press-molding step.

By carrying out the external force-imparting step to the glass material to be press-molded, the molten glass gob formed by separating from the molten glass flow turns. Thus, in the stage in which the molten glass gob falls and reaches the space between the molding surface of the first press mold and the molding surface of the second press mold, the separation mark positioned in the upper surface of the molten glass gob at the time of its separation moves to a side surface side of the molten glass gob and faces any one of the molding surface sides. Then, the molten glass gob in this state is press-molded by being pressed from the horizontal direction by the first press mold and the second press mold. That is, the press-molding step is carried out under a state in which the separation mark causing a shear mark to occur faces any one of the molding surface sides. As a result, the shear mark remaining in the glass blank is eventually localized in the vicinity of the central portion of the glass blank. In this case, the shear mark can be removed together with the central portion (central hole-forming region) of the glass blank because a central hole is formed at the time of manufacturing a magnetic recording medium substrate. Thus, it is not necessary to provide a large amount of a grinding allowance and/or a polishing allowance in order to remove the shear mark, and eliminating a lapping step or carrying out a lapping step in a shorter time can be realized.

Here, the molten glass gob may only be turned so that the molten glass gob faces any one of the molding surfaces. In this case, the phrase “the molten glass faces any one of the molding surfaces” includes not only the case where the separation mark existing in the surface of the molten glass gob just prior to carrying out the press-molding step is (1) positioned on the straight line connecting, in the shortest distance, the central point of the molten glass gob and any one molding surface selected from the molding surface of the first press mold and the molding surface of the second press mold, but also the case where the separation mark is (2) positioned in the range made by the straight line and another straight line having an angle of about 45° or less based on the central point of the molten glass gob with respect to the straight line. Note that the angle is preferably 30° or less, more preferably 15° or less. In the case of the above-mentioned item (1), when press-molding is carried out, the separation mark first comes into contact with the molding surface and the molten glass gob in this state is press-molded, and hence the shear mark is eventually positioned in the almost central portion of the glass blank. On the other hand, in the case of the above-mentioned item (2), when press-molding is carried out, a part of the surface of the molten glass gob in the vicinity of the separation mark comes into contact with the molding surface at first. In this case, the shear mark is also eventually positioned in the vicinity of the central portion of the glass blank, though slight displacement of the shear mark is more liable to occur compared with the case of the above-mentioned item (1). Note that the mode shown in the above-mentioned item (1) is most preferred from the viewpoint that the shear mark can be positioned more reliably in the central portion of the glass blank or in the vicinity of the central portion.

A method of forming a molten glass gob in the molten glass gob-forming step is not particularly limited, and is usually carried out by using a pair of shear blades. In this case, the separation of the forward end portion of the molten glass flow is carried out by causing the pair of shear blades to cross with respect to the molten glass flow in the direction substantially perpendicular to the falling direction of the molten glass flow. Note that the shape of the blade portion of each of the shear blades is not particularly limited as long as the shape is one suitable for separating (cutting) the forward end portion of the molten glass flow, and the shape is preferably one selected from a V shape and a U shape.

Note that, in the case of using a pair of shear blades, it is necessary that the movement direction in which the pair of shear blades approaches to or separates from each other at the time of forming a molten glass gob and the movement direction in which a pair of press molds approaches to or separates from each other at the time of press-molding be substantially parallel based on the horizontal plane. Specifically, the angle that is made by these two movement directions in the horizontal plane needs to be 10° or less, and is preferably 5° or less, most preferably 0°. In the case where the two movement directions are substantially parallel based on the horizontal plane, when the molten glass gob turns and the separation mark thereby moves from the upper surface of the molten glass gob to one of its side surface sides, the separation mark existing in the surface of the molten glass gob just prior to carrying out the press-molding step can face reliably any one of the molding surfaces of the pair of press molds. Note that a pair of shear blades is generally used to form a molten glass gob, but Patent Literature 1 does not disclose anything about the relationship in position based on the horizontal plane between the above-mentioned two movement directions.

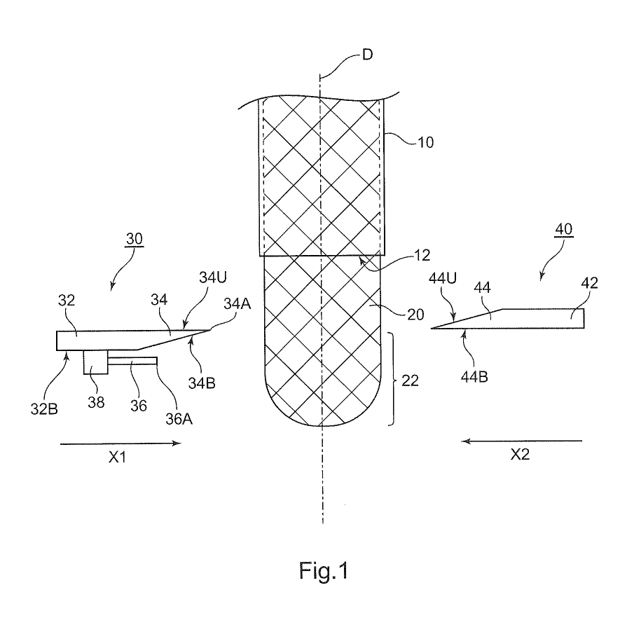

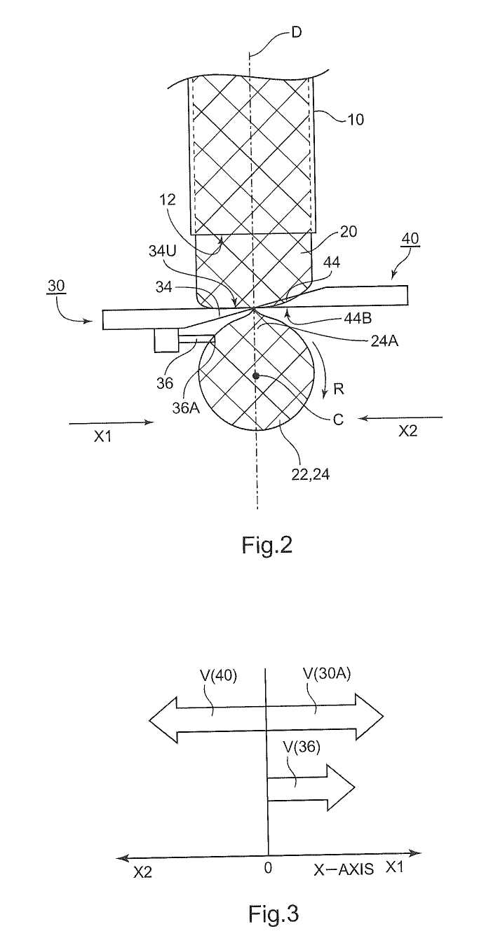

FIG. 1 and FIG. 2 are schematic cross-sectional views illustrating one example of the method of manufacturing a glass blank in the first embodiment. Specifically, both are views illustrating a process in which the forward end portion of a molten glass flow with a pair of shear blades is cut. Here, FIG. 1 illustrates the state of before cutting the forward end portion of the molten glass flow, and FIG. 2 illustrates the state of around the completion of cutting of the forward end portion of the molten glass flow.

As illustrated in FIG. 1, a molten glass flow 20 is first caused to flow out continuously downward in the vertical direction from a glass outlet 12 provided at the lower end portion of a glass effluent pipe 10 whose upper end portion is connected to a molten glass supply source not shown. On the other hand, at a portion lower than the glass outlet 12, a first shear blade (lower side blade) 30 and a second shear blade (upper side blade) 40 are arranged at both sides of the molten glass flow 20, respectively, in the direction substantially perpendicular to a central axis D, which is the falling direction of the molten glass flow 20. Then, the lower side blade 30 and the upper side blade 40 move toward an arrow direction X1 and an arrow direction X2, respectively, thereby approaching to a forward end portion 22 side of the molten glass flow 20 from both sides of the molten glass flow 20.

Here, the lower side blade 30 and the upper side blade 40 have substantially plate-shaped body portions 32 and 42, respectively, and blade portions 34 and 44, respectively, which are respectively provided at an end portion side of the body portions 32 and 42, and cut the forward end portion 22 of the molten glass flow 20 continuously flowing out downward in the vertical direction in the direction substantially perpendicular to the direction to which the molten glass flow 20 falls down. Note that an upper surface 34U of the blade portion 34 and a lower surface 44B of the blade portion 44 each have a surface substantially corresponding to the horizontal plane, a lower surface 34B of the blade portion 34 and an upper surface 44U of the blade portion 44 each have a surface that is slanted so as to cross the horizontal plane. Besides, the lower side blade 30 further includes a pressing member 36, which is provided at a lower surface 32B side of the body portion 32, stretches to a blade portion 34 side from a body portion 32 side, and presses the forward end portion 22 in collaboration with the movement that the blade portion 34 approaches to and penetrates into the molten glass flow 20 at the time of cutting the molten glass flow 20. In addition, the lower side blade 30 and the upper side blade 40 are arranged so that the upper surface 34U of the blade portion 34 and the lower surface 44B of the blade portion 44 are positioned at substantially the same height in the vertical direction.

Note that, in the example illustrated in FIG. 1, the pressing member 36, which is a bar-shaped member provided so as to be attachable to and detachable from the body portion 32, is fitted to the lower portion of the body portion 32 so as to be substantially parallel to the substantially plate-shaped body portion 32. In addition, the body portion 32 includes a fitting portion 38 for fitting the pressing member 36. In addition, the position of a tip 36A on a blade portion 34 side of the pressing member 36 is adjustable by, for example, changing to another pressing member 36 having a different length or sliding the pressing member 36 in the horizontal direction with respect to the fitting portion 38. Here, the position of the tip 36A of the pressing member 36 is adjusted, based on the central axis D of the glass effluent pipe 10, so as to fall within the range covering the positions that are more distant from the central axis D, in the arrow direction X1, compared with the position of a tip 34A of the blade portion 34. This is because, when the position of the tip 36A deviates from this range, the pressing member 36 comes into contact with the forward end portion 22 earlier than the blade portion 34 at the time of separating (cutting) the forward end portion 22, and hence it becomes highly possible that the forward end portion 22 separated falls in an obliquely downward direction instead of the downward vertical direction. Note that the pressing member 36 may be one that is integrally provided to the body portion 32 in a non-attachable and non-detachable manner, or may be one having a shape other than a bar shape, such as a plate shape.

Note that the viscosity of the molten glass flow 20 is not particularly limited as long as the viscosity is suitable for separating the forward end portion 22 and press-molding, and it is usually preferred that the viscosity be controlled to a constant value in the range of 500 dPa·s to 1,050 dPa·s.

Next, as illustrated in FIG. 2, the lower side blade 30 and the upper side blade 40 are each moved in the horizontal direction so that the upper surface 34U of the blade portion 34 and the lower surface 44B of the blade portion 44 are partially overlapped substantially without any gap by further moving the lower side blade 30 and the upper side blade 40 toward the arrow direction X1 and the arrow direction X2, respectively. That is, the lower side blade 30 and the upper side blade 40 are caused to perpendicularly cross the central axis D. As a result, the lower side blade 30 and the upper side blade 40 penetrate into the molten glass flow 20 until reaching the vicinity of the central axis D thereof, and the forward end portion 22 is separated (cut) as a molten glass gob 24 having a substantially spherical shape. At that time, a separation mark (cut mark) 24A is formed in an upper surface of the molten glass gob 24.

Further, at around the timing of cutting, the tip 36A of the pressing member 36 comes into contact with an upper side surface of the forward end portion (glass material to be press-molded) 22 just under separation and/or an upper side surface of the molten glass gob (glass material to be press-molded) 24 completely separated from the molten glass flow 20, followed by pressing. In this case, to the upper hemisphere side of each of the glass materials to be press-molded 22 and 24, external forces are applied from the direction crossing the vertical direction so that the vector sum of the forces acting in the direction (the X-axis direction parallel to the arrow direction X1 and the arrow direction X2 in the figure) perpendicular to the central axis D of the glass materials to be press-molded 22 and 24, the central axis D being parallel to the vertical direction, substantially exceeds zero.

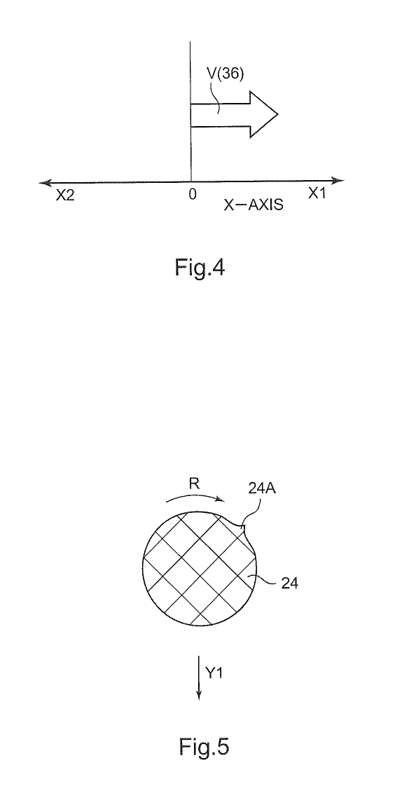

Here, FIG. 3 and FIG. 4 are graphs illustrating examples of the vectors of forces acting in the X-axis direction on the upper hemisphere of each of the glass materials to be press-molded 22 and 24. Here, in FIG. 3 and FIG. 4, the horizontal axis means the X-axis direction, the right side direction represents the X1 direction, which is the moving direction of the lower side blade 30 at the time of cutting, and the left side direction represents the X2 direction, which is the moving direction of the upper side blade 40 at the time of cutting, based on the original point 0. Further, vectors V (30A), V(40), and V(36) illustrated in FIG. 3 and FIG. 4 mean vectors attributed to the lower side blade 30, the upper side blade 40, and the pressing member 36, respectively, that is, each mean the force of the component acting in the X-axis direction in each of three exterior forces attributed to the lower side blade 30, the upper side blade 40, and the pressing member 36, respectively, the exterior forces being applied to the upper portions of the glass materials to be press-molded 22 and 24 at around the time of cutting.

Here, the two vectors V (30A) and V (40) attributed to the lower side blade 30 and the upper side blade 40, respectively, are vectors having substantially the same magnitude, each acting in completely reverse directions. At the time of cutting, when the lower side blade 30 and the upper side blade 40 start penetrating into the molten glass flow 20, the magnitudes of the vectors V (30A) and V (40) each start increasing from 0 and then reach a maximum value. After that, when the cutting finishes and the upper surface of the molten glass gob 24 separates from the lower side blade 30 and the upper side blade 40, the magnitudes of the vectors each return to 0. That is, these two vectors V(30A) and V(40) have a relationship of almost cancelling each other in the molten glass gob-forming step, and hence the difference of the magnitudes of the vectors V(30A) and V(40) seems to be kept at 0 substantially.

Then, when the forward end portion (glass material to be press-molded) 22 which is just under separation is pushed by the tip 36A of the pressing member 36, as illustrated in FIG. 3, the vector V(36) in the X1 direction additionally acts in addition to the two vectors V(30A) and V(40) always cancelling each other. Thus, the vector sum of the forces acting in the X-axis direction well exceeds 0 substantially depending on the additional action of the vector V(36). On the other hand, when the molten glass gob (glass material to be press-molded) 24 separated from the molten glass flow 20 is pushed by the tip 36A of the pressing member 36, the magnitudes of the vectors V(30A) and V(40) illustrated in FIG. 3 both become 0, and, as illustrated in FIG. 4, only the vector V(36) acts. As a result, the vector sum of the forces acting in the X-axis direction well exceeds 0 substantially.

Note that, in the example illustrated in FIG. 2, the vector V(36) may be caused to act in only the mode illustrated in FIG. 3, in which the lower side blade 30 and the upper side blade 40 are penetrating into the molten glass flow 20, the vector V(36) may be caused to act in only the mode illustrated in FIG. 4, which illustrates the state of after the completion of the penetration of the lower side blade 30 and the upper side blade 40 into the molten glass flow 20, or the vector V(36) may be caused to act in both the modes illustrated in FIG. 3 and FIG. 4.

When external forces are applied to each of the glass materials to be press-molded 22 and 24 in the modes illustrated in FIG. 3 and/or FIG. 4, the position at which the vector V(36) acts is a position located at an upper portion in the left side with respect to the central point C of each of the glass materials to be press-molded 22 and 24 in FIG. 2, and hence each of the glass materials to be press-molded 22 and 24 eventually turns in the clockwise direction R with respect to the central point C in FIG. 2. Thus, as illustrated in FIG. 5, in the process in which the molten glass gob 24 is falling in the vertical direction in the downward Y1 (falling direction) side, the separation mark 24A that was positioned in the vertical direction in the upper side with respect to the central point C of the molten glass gob 24 immediately after its separation eventually moves in the clockwise direction R with respect to the central point C.

Note that, in the example illustrated FIG. 2, there is used the pressing member 36 which is fitted to the lower side blade 30 and presses the upper portion side of each of the glass materials to be press-molded 22 and 24 in collaboration with the lower side blade 30. However, the pressing member 36 for pressing each of the glass materials to be press-molded 22 and 24 may be arranged at a position separated from the lower side blade 30 and the upper side blade 40 so as to press each of the glass materials to be press-molded 22 and 24. Further, as exemplified in FIG. 3 and FIG. 4, as long as the pressing by the pressing member 36 is carried out so that the vector sum of the forces acting in the X-axis direction of each of the glass materials to be press-molded 22 and 24 exceeds 0 substantially, the position at which and the direction to which each of the glass materials to be press-molded 22 and 24 is pressed may be selected arbitrarily. For example, the lower portion side of each of the glass materials to be press-molded 22 and 24 can be pressed in the horizontal direction by the pressing member 36. Note that the phrase “the case where the vector sum of the forces acting in the X-axis direction of each of the glass materials to be press-molded 22 and 24 does not exceed 0 substantially (the case where the vector sum is near 0)” means, for example, the case where, in order only to simply separate the forward end portion 22 of the molten glass flow 20, a pair of shear blades is moved in the horizontal direction, and the shear blades are moved at almost the same speed in the X1 direction and the X2 direction, respectively, so that surfaces of the shear blades slide to each other. Further, as exemplified in FIG. 3 and FIG. 4, as long as an external force that produces the vector of the force acting in the X-axis direction aiming at turning the molten glass gob 24 is applied to each of the glass materials to be press-molded 22 and 24 from the direction crossing the vertical direction, for example, the direction from which and the position at which the external force is applied to each of the glass materials to be press-molded 22 and 24 are not particularly limited. However, when the external force is applied, it is particularly preferred that the central point C of each of the glass materials to be press-molded 22 and 24 (Note that, in the case of the forward end portion 22 before separation, the central point C corresponds to the position that is to be the central point of the molten glass gob 24 after being cut.) be not positioned on the direction in which the external force is applied. This is because, when the central point C of each of the glass materials to be press-molded 22 and 24 is positioned on the direction in which the external force is applied, turns are unlikely to occur. Note that, more exactly, when the central point C of each of the glass materials to be press-molded 22 and 24 is positioned on the direction in which the external force is applied, any force for causing turns does not occur at that moment. However, the molten glass gob 24 continuously falls and the position of the central point C continuously moves downward, and moreover, the forward end portion 22 is separated in an extremely short time and falls as the molten glass gob 24. Thus, the central point C moves downward during the period in which the external force is continuously applied. As a result, though turns become difficult to occur, it is completely unlikely that turns do not occur at all.

Note that the application of an external force to each of the glass materials to be press-molded 22 and 24 aiming at turning the molten glass gob 24 is also possible by controlling the shape of a shear blade or the speed and timing of the movement of a pair of shear blades instead of using the pressing member 36. For example, when a lower side blade including no pressing member 36 is used in FIG. 1 and FIG. 2, (1) many projections are provided in the lower surface 34B, which comes into contact with the upper surface of the forward end portion (glass material to be press-molded) 22 that is under separation, for a longer time than the lower surface 44B, roughening treatment is carried out on the surface of the lower surface 34B, the surface of the lower surface 34B is coated with a material having higher wettability with respect to molten glass, or the like, thereby being able to apply an external force more easily in the X1 direction to the upper surface of the forward end portion (glass material to be press-molded) 22 that is under separation. This is because, in this case, there is increased a frictional force between the upper surface of the forward end portion (glass material to be press-molded) 22 that is under separation, and the lower surface 34B, and hence the upper surface of the forward end portion (glass material to be press-molded) 22 that is under separation becomes more likely to move in the X1 direction by being involved in the movement of the lower surface 34B. In this case, the magnitude of the vector V (30A) is always larger than the magnitude of the vector V(40) during the cutting, and hence the vector sum of the forces acting in the X-axis direction well exceeds 0 substantially.

(2) Further, when, during the upper side blade 40 is earlier being penetrated into the molten glass flow 20 by moving the upper side blade 40 in the X2 direction, the lower side blade including no pressing member 36 is penetrated into the molten glass flow 20 by moving the lower side blade in the X1 direction at a relatively higher speed than the upper side blade 40, there act two external forces acting in opposite directions caused by the penetration of the lower side blade 30 and the upper side blade 40 into the molten glass flow 20, and moreover, there acts a third external force, which is produced when the lower surface 34B, which comes into contact with the upper surface of the forward end portion (glass material to be press-molded) 22 that is under separation, for a longer time than the lower surface 44B, strongly rubs the upper surface of the forward end portion (glass material to be press-molded) 22 in the arrow X1 direction side. In this case, the third external force strongly acts at the stage of just before and immediately after the cutting, and hence the vector sum of the forces acting in the X-axis direction well exceeds 0 substantially.

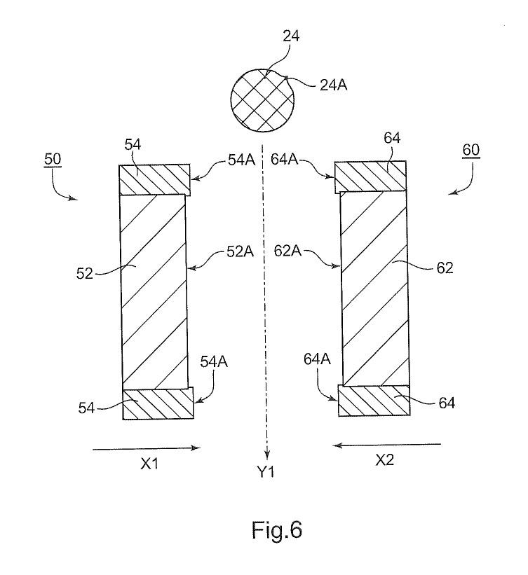

The molten glass gob 24 in which the separation mark 24A that was positioned in the vertical direction in the upper side with respect to the central point C of the molten glass gob 24 immediately after its separation moved in the clockwise direction with respect to the central point C in FIG. 5 further falls in the vertical direction in the downward Y1 side. Then, the molten glass gob 24 enters the space between the first press mold and the second press mold both arranged so as to face each other in the direction perpendicular to the falling direction Y1 of the molten glass gob 24. Here, as illustrated in FIG. 6, a first press mold 50 and a second press mold 60 before carrying out press-molding are arranged with a distance between them so as to have line symmetry with respect to the falling direction Y1. Then, in synchronization with the timing when the molten glass gob 24 reaches the vicinity of the central portion in the vertical direction of the first press mold 50 and the second press mold 60, the first press mold 50 moves in the arrow X1 direction and the second press mold 60 moves in the arrow X2 direction in order to press-mold the molten glass gob 24 by pressing it from both sides.

Here, the press molds 50 and 60 have press mold bodies 52 and 62 each having a disk-like shape, respectively, and guide members 54 and 64 arranged so as to surround the outer peripheral ends of each of the press mold bodies 52 and 62, respectively. Note that, because FIG. 6 is a cross-sectional view, the guide members 54 and 64 are drawn so as to be positioned on both sides of the press mold bodies 52 and 62, respectively, in FIG. 6. Here, one surface of each of the press mold bodies 52 and 62 serves as a molding surface 52A and 62A, respectively. Further, in FIG. 6, the first press mold 50 and the second press mold 60 are arranged so that the two molding surfaces 52A and 62A face each other. Further, the guide member 54 is provided with a guide surface 54A, which is positioned so as to project slightly based on the molding surface 52A in the X1 direction, and the guide member 64 is provided with a guide surface 64A, which is positioned so as to project slightly based on the molding surface 62A in the X2 direction. Then, the guide surface 54A and the guide surface 64A come into contact with each other at the time of press-molding, and hence a gap is formed between the molding surface 52A and the molding surface 62A. Thus, the thickness of the gap corresponds to the thickness of the molten glass gob 24 molded so as to have a plate shape by being press-molded between the first press mold 50 and the second press mold 60, that is, the thickness of a glass blank. Further, as illustrated in FIG. 6, the molding surfaces 52A and 62A are formed so that, when the molten glass gob 24 is pressed and spread completely in the vertical direction and molded into a flat glass between the molding surface 52A of the first press mold 50 and the molding surface 62A of the second press mold 60 by carrying out the press-molding step, at least a region contacting the above-mentioned flat glass in each of the molding surfaces 52A and 62A forms a flat surface.

It is preferred to use a metal or an alloy as a material for forming each of the press molds 50 and 60 in view of heat resistance, workability, and durability. In this case, the heat resistant temperature of the metal or alloy for forming each of the press molds 50 and 60 is preferably 1,000° C. or more, more preferably 1,100° C. or more. Specific examples of the material for forming each of the press molds 50 and 60 preferably include ferrum casting ductile (FCD), alloy tool steel (such as SKD61), high-speed steel (SKH), cemented carbide, Colmonoy, and Stellite.

The glass blank is manufactured by pressing and press-molding the molten glass gob 24 with the molding surfaces 52A and 62A. Thus, the surface roughness of the molding surfaces 52A and 62A and the surface roughness of the main surface of the glass blank become substantially the same. The surface roughness (center line surface roughness Ra) of the main surface of the glass blank is desirably controlled to the range of 10 μm or less in view of performing scribe processing and performing grinding processing using a diamond sheet, and these processings are carried out as the below-mentioned post-step. Thus, the surface roughness (center line surface roughness Ra) of the press-molding surfaces is also preferably controlled to the range of 10 μm or less.

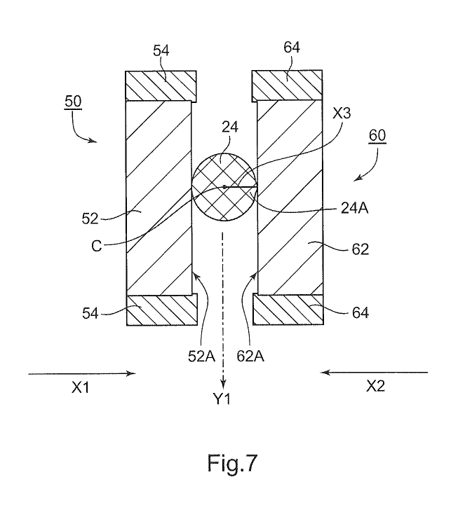

The molten glass gob 24 illustrated in FIG. 6 falls further downward and enters the space between the two press-molding surfaces 52A and 62A. Then, as illustrated in FIG. 7, at the time when the molten glass gob 24 reaches the vicinity of the almost central portion in the vertical direction of the press-molding surfaces 52A and 62A parallel to the falling direction Y1, both side surfaces of the molten glass gob 24 come into contact with the press-molding surfaces 52A and 62A. In this case, the separation mark 24A and a surface portion of the molten glass gob 24, the surface portion being located at a position having the point symmetry with the separation mark 24A with respect to the central point C of the molten glass gob 24, preferably first come into contact with the press-molding surface 62A and the press-molding surface 52A, respectively, at substantially the same time. At the stage of immediately before carrying out this press-molding step, the separation mark 24A is positioned on the straight line having an angle of 0° based on the central point C of the molten glass gob 24 with respect to a straight line X3 connecting the central point C with the press-molding surface 62A in the shortest distance.

Note that it may be possible to adopt a mode in which the molten glass gob 24 falls while continuously turning until the time of the start of the press-molding (hereinafter, referred to as “continuously turning-type falling”). Alternatively, it may be possible to adopt a mode in which the molten glass gob 24 turns for a moment when an external force is applied from the direction crossing the vertical direction and then, the molten glass gob 24 falls while maintaining that state until the time of the start of the press-molding, so that the vector sum of the forces acting in the X-axis direction of the glass materials to be press-molded 22 and 24 exceeds 0 substantially (hereinafter, referred to as “turning stop-type falling”). However, in any of the cases, at the stage of immediately before carrying out the press-molding step illustrated in FIG. 7, it is necessary, as described above, for the separation mark 24A to be positioned in the range made by the straight line X3 and another straight line having an angle (hereinafter, referred to as “turning angle” in some cases) of 45° or less based on the central point C of the molten glass gob 24 with respect to the straight line X3.

Here, in order to control the turning angle at the time of the start of the press-molding within the above-mentioned range, (1) in the case of the turning stop-type falling, the purpose can be attained by controlling the direction, intensity, and the like of the external force at the time of turning the molten glass gob 24, and (2) in the case of the continuously turning-type falling, the purpose can be attained by controlling a) the direction and intensity of the external force at the time of turning the molten glass gob 24, b) the falling distance, and the like. Here, the term “falling distance” means a distance from the position at which the separation mark 24A is first formed as exemplified in FIG. 2, that is, the position at which the lower side blade 30 and the upper side blade 40 are overlapped in the vertical direction, to the position of the molten glass gob 24 at the time of the start of the press-molding as exemplified in FIG. 7, that is, the vicinity of the almost central portion in the diameter direction of the press-molding surfaces 52A and 62A parallel to the falling direction Y1. Note that, in additional consideration of the viewpoint of preventing the situation that press-molding becomes difficult to carry out because of the increase of the viscosity of a falling molten glass gob 24 or the situation that the position of press fluctuates because of an excessively high falling speed, the falling distance is preferably selected from the range of 1,000 mm or less, more preferably selected from the range of 500 mm or less, still more preferably selected from the range of 300 mm or less, most preferably selected from the range of 200 mm or less. Note that the lower limit of the falling distance is not particularly limited, but is preferably 75 mm or more for practical use.

It is possible to adopt, as a method of controlling the turning angle at the time of the start of the press-molding within the above-mentioned range, for example, the method (1) or (2) described below.
(1) Under a state in which separation conditions of the molten glass gob 24 (such as the driving timings of the shear blades 30 and 40) and the driving timings of the press molds 50 and 60 are made constant, the appearance of how the molten glass gob 24 falls is monitored by using a high-speed camera. Then, based on the results of the monitoring, the falling distance is adjusted so that the turning angle at the time of the start of the press-molding falls within the above-mentioned range.
(2) Under a state in which the falling distance is made constant, the appearance of how the molten glass gob 24 falls is monitored by using a high-speed camera. Then, based on the results of the monitoring, separation conditions of the molten glass gob 24 (such as the driving timings of the shear blades 30 and 40) are adjusted so that the turning angle at the time of the start of the press-molding falls within the above-mentioned range.

Note that the temperatures of the first press mold 50 and second press mold 60 at the time of the start of the press-molding are each preferably set to a temperature less than the glass transition temperature of a glass material forming the molten glass gob 24. With this, it is possible to prevent more reliably the phenomenon that, when the molten glass gob 24 is press-molded, the melt-bonding between the thinly stretched molten glass gob 24 and each of the molding surfaces 52A and 62A occurs.

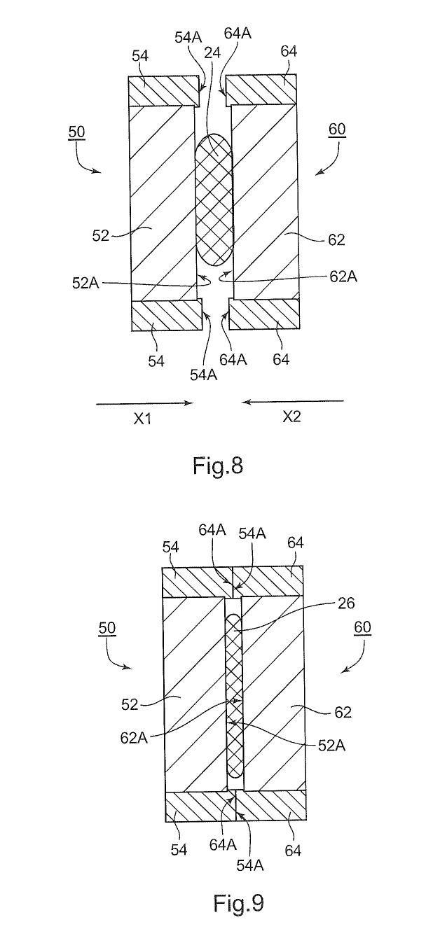

After the surface of the molten glass gob 24 comes into contact with each of the molding surfaces 52A and 62A, the molten glass gob 24 is solidified so as to attach to the molding surfaces 52A and 62A. Next, as illustrated in FIG. 8, when the molten glass gob 24 is continuously pressed from its both sides with the first press mold 50 and the second press mold 60, the molten glass gob 24 is pressed and spread so as to have a uniform thickness around the position at which the molten glass gob 24 and each of the molding surfaces 52A and 62A first come into contact. Then, as illustrated in FIG. 9, the molten glass gob 24 is continuously pressed with the first press mold 50 and the second press mold 60 until the guide surface 54A and the guide surface 64A come into contact, thereby being formed into a disk-shaped or disk-like thin flat glass 26 between the molding surfaces 52A and 62A. Thus, as illustrated in FIG. 7, when the separation mark 24A first comes into contact with the molding surface 62A, the separation mark 24A (not shown in FIG. 9) is eventually positioned in a surface of the thin flat glass 26, the surface facing the molding surface 62A.

Here, the thin flat glass 26 illustrated in FIG. 9 has substantially the same shape and thickness as the glass blank to be finally obtained. Further, the time taken from the state at the time of the start of the press-molding illustrated in FIG. 7 until a state in which the guide surface 54A and the guide surface 64A come into contact with each other as illustrated in FIG. 9 (hereinafter, referred to as “press-molding time” in some cases) is preferably 0.1 second or less from the viewpoint of forming the molten glass gob 24 into a thin flat glass. Moreover, because a state in which the guide surface 54A and the guide surface 64A come into contact with each other is established at the time of the press-molding, it becomes easy to maintain the parallel state between the molding surface 52A and the molding surface 62A. Note that the upper limit of the press-molding time is not particularly limited.

Note that after the state illustrated in FIG. 9 is established, it is possible to continue applying a pressure sufficiently smaller than a press pressure applied to the first press mold 50 and the second press mold 60, so that a state in which the guide surface 54A and the guide surface 64A are in contact is maintained, thereby maintaining a state in which both surfaces of the thin flat glass 26 and each of the molding surfaces 52A and 62A are closely attached. Then, while the state is continued for several seconds, the thin flat glass 26 is cooled. Here, cooling the thin flat glass 26 in a state in which the thin flat glass 26 is sandwiched between the first press mold 50 and the second press mold 60 is preferably carried out until the temperature of the thin flat glass 26 reaches a temperature equal to or less than the deformation point of a glass material forming the thin flat glass 26. Note that if the press pressure is increased in the above-mentioned state, the thin flat glass 26 breaks in some cases.

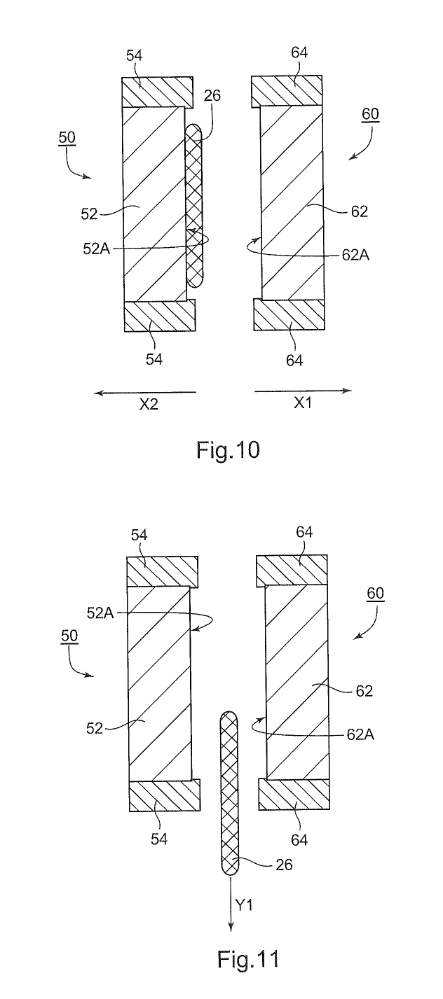

Next, as illustrated in FIG. 10, the first press mold 50 is moved in the X2 direction and the second press mold 60 is moved in the X1 direction so that the first press mold 50 and the second press mold 60 are separated from each other, thereby demolding the thin flat glass 26 from the molding surface 62A. Subsequently, as illustrated in FIG. 11, the thin flat glass 26 is demolded from the molding surface 52A, and the thin flat glass 26 is caused to fall in the downward Y1 side in the vertical direction so as to be taken out. Note that when the thin flat glass 26 is demolded from the molding surface 52A, the thin flat glass 26 can be demolded by applying a force from an outer peripheral direction of the thin flat glass 26 so as to peel it, or the thin flat glass 26 can also be demolded by cooling with air the surface of the thin flat glass 26 so as to contract glass. In this case, the thin flat glass 26 can be taken out without applying a large force to the thin flat glass 26. Note that, it may be possible to control the press-molding by cooling the first press mold 50 and the second press mold 60 by using a medium for cooling such as water or air so that the temperatures of the molding surfaces 52A and 62A do not excessively rise.

Finally, the thin flat glass 26 taken out is subjected to annealing to reduce or remove strain, thereby yielding a base material to be processed into a magnetic recording medium substrate, that is, a glass blank. Further, the glass blank locally includes a shear mark attributed to the separation mark 24A in the vicinity of the central portion of its main surface. Thus, a region including the shear mark can be removed by the central hole-forming processing that is carried out at the time of manufacturing a magnetic recording medium substrate.

Note that, when the viscosity of the molten glass flow 20 is less than 500 dPa·s, it may become difficult to separate the molten glass gob 24 in a necessary amount in a state in which the molten glass flow 20 is falling in the air. Thus, when the viscosity of the molten glass flow 20 is less than 500 dPa·s, a necessary amount of molten glass for obtaining the molten glass gob 24 is accumulated by supporting the forward end portion 22 of the molten glass flow 20 below the glass outlet 12, and the molten glass gob 24 is then separated. Then, it is recommended that an exterior force be applied to the thus obtained molten glass gob 24 so that the molten glass gob 24 turns around the central point C as the base, followed by falling of the molten glass gob 24, and press-molding be started under a state in which the separation mark 24A faces the molding surface 52A or the molding surface 62A.

By subjecting the molten glass gob 24 that is falling to press-molding, the viscosity distribution of the molten glass gob 24 just before the start of the press-molding is made uniform, and the molten glass gob 24 can be stretched more easily so as to have a uniform, small thickness. When the inner diameter of the central hole formed in the magnetic recording medium substrate is small, the size of a shear mark formed in the glass blank is made smaller so that the shear mark is located in the range in which the central hole of the glass blank is formed.

In this case, it is effective that the cross section of the vicinity of the forward end portion 22 of the molten glass flow 20 along the plane perpendicular to the direction to which the molten glass flow 20 falls has a substantially elliptical shape with a major axis and a minor axis. In above-mentioned case, the separation of the forward end portion 22 of the molten glass flow 20 is carried out as follows. That is, a pair of shear blades is penetrated into the molten glass flow 20 from directions opposite to each other, the directions crossing the vertical direction, the directions which are substantially perpendicular to direction to which the molten glass flow 20 falls and directions which are almost corresponding in the major axis direction of the cross section of the vicinity of the forward end portion 22 of the molten glass flow 20. Separating the forward end portion 22 of the molten glass flow 20 as described above can make the shear mark smaller. In this case, even if the inner diameter of the central hole is small, the shear mark can be localized in the range in which the central hole of the glass blank is formed. Note that, in order to make the cross section of the vicinity of the forward end portion 22 of the molten glass flow 20 have a substantially elliptical shape, it is possible to adopt, for example, a method involving making the aperture shape of the glass outlet 12 elongated and a method involving modifying the cross-sectional shape so as to be elongated by sandwiching the molten glass flow 20 from its both sides along the direction to which the molten glass flow 20 falls. Further, as a technique for making a shear mark smaller, a method involving cutting a molten glass flow by using a pair of shear blades in which each blade portion is branched and has a V shape or a U shape is also effective. In this case, as exemplified in FIG. 2, the separation of the forward end portion 22 of the molten glass flow 20 is carried out by causing a pair of the shear blades 30 and 40 to penetrate into the molten glass flow 20 from directions opposite to each other, the directions crossing the vertical direction and being substantially perpendicular to the direction to which the molten glass flow 20 falls.

Further, the size of the shear mark formed in the glass blank increases and decreases depending on the inner peripheral length of the glass outlet 12. As the inner peripheral length of the glass outlet 12 increases, the size of the shear mark also increases, and as the inner peripheral length of the glass outlet 12 decreases, the size of the shear mark also decreases. Thus, in order to make the size of the shear mark smaller than the diameter of the central hole, it is recommended to make the inner peripheral length of the glass outlet 12 smaller, that is, make the inner diameter of the glass outlet 12 smaller, as long as the outflow amount per unit time of the molten glass flow 20 is controlled to a predetermined amount. For example, if an outflowing molten glass has a viscosity of 700 dPa·s and the inner peripheral length of the glass outlet 12 is set to 47 mm (which corresponds to an inner diameter of about 15 mm when the glass outlet 12 has a circular shape), the outflow amount per unit time of the molten glass flow 20 becomes 500 g/minute (which corresponds to 50 glass blanks) and the size of the shear mark becomes 18 mm, and hence the size of the shear mark can be made smaller than 20 mm, which is the diameter of the central hole of a magnetic recording medium substrate with a 2.5 inch size. Further, if the viscosity of the outflowing molten glass flow 20 is kept at the above-mentioned value and the inner peripheral length of the glass outlet 12 is set to 41 mm (which corresponds to an inner diameter of about 13 mm), the outflow amount per unit time of the molten glass flow 20 becomes 350 g/minute (which corresponds to 35 glass blanks) and the size of the shear mark becomes 15 mm, and hence the size of the shear mark can be made smaller than 20 mm, which is the diameter of the central hole of the magnetic recording medium substrate with a 2.5 inch size. As described above, the size of the shear mark can be controlled so as to fall within the diameter of the central hole of the magnetic recording medium substrate.

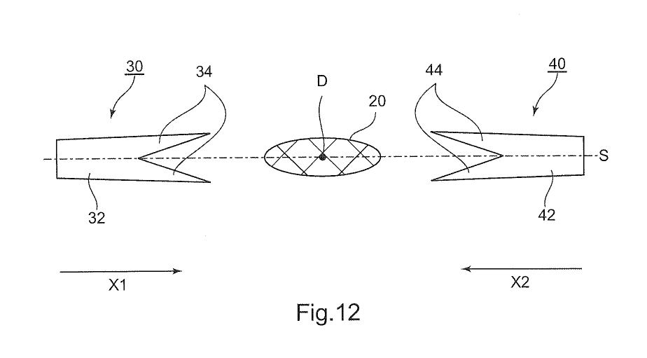

FIG. 12 is a schematic cross-sectional view illustrating one example of separation of a forward end portion of a molten glass flow using a pair of shear blades. Here, FIG. 12 is a view specifically illustrating the case where the cross section (horizontal cross section) of the molten glass flow 20 along a plane perpendicular to the central axis D in FIG. 1 has a substantially elliptical shape. Here, in the figure, an alternate long and short dash line S means the direction that agrees with the major axis direction of the molten glass flow 20 having an elliptical shape as the horizontal cross section, and is parallel to the arrow X1 direction and the arrow X2 direction. In the example illustrated in FIG. 12, a pair of the shear blades 30 and 40 is penetrated into the molten glass flow 20 from directions opposite to each other, the directions crossing the vertical direction (central axis D), being perpendicular to the direction (central axis D) to which the molten glass flow 20 falls, and agreeing with the major axis direction S of the horizontal cross section of the molten glass flow 20 (penetration is caused by moving the lower side blade 30 in the X1 direction and moving the upper side blade 40 in the X2 direction).

A glass blank is produced by utilizing horizontal direct press in the method of manufacturing a glass blank in the first embodiment, and hence a glass blank having a small thickness deviation and a small flatness can be easily obtained. Note that the thickness deviation of the glass blank that is manufactured is preferably 10 μm or less, and the flatness of the glass blank is preferably 10 μm or less, more preferably 8 μm or less, still more preferably 6 μm or less, particularly preferably 4 μm or less.

The method of manufacturing a glass blank in the first embodiment is suitable for producing a glass blank having a ratio of diameter to thickness (diameter/thickness) of 50 to 150. Here, the diameter refers to an arithmetic average of the major axis and minor axis of the glass blank. The press molds 50 and 60 do not regulate the outer peripheral end surface of the glass blank, and hence the outer peripheral end surface is a free surface. Here, the circularity of the glass blank that is produced is not particularly limited, but is preferably controlled to within ±0.5 mm.

The diameter of the glass blank is not particularly limited. The diameter is preferably set, as a target value, to a value obtained by adding, to the diameter of the substrate, the amount of glass that is removed at the time of scribe processing and outer peripheral processing which are carried out when the glass blank is processed into a magnetic recording medium substrate, as described below.

The thickness of the glass blank falls preferably within the range of 0.75 to 1.1 mm, more preferably within the range of 0.75 to 1.0 mm. It is recommended to measure the thickness, thickness deviation, flatness, diameter, and circularity of the glass blank by using a three-dimensional measuring machine and a micrometer.

It is recommended that the composition of glass to be used be appropriately selected depending on the properties that are required for a magnetic recording medium substrate. Examples of the glass include alumino silicate glass, soda lime glass, soda alumino silicate glass, and alumino borosilicate glass. Further, these kinds of glass may be crystallized glass, which is crystallized by heat treatment, and can be crystallized by heat treatment and then processed into a magnetic recording medium substrate.

Glass used for a magnetic recording medium substrate that is utilized for producing a magnetic recording medium such as a magnetic disk desirably has chemical durability, large rigidity, and a high thermal expansion coefficient. Further, when importance is given to enhancing bending strength, the glass is required to have a composition that is suitable for undergoing chemical strengthening, and when high-temperature heat treatment is carried out in a process of producing a magnetic recording medium, the glass is desired to have a composition that is suitable for exhibiting good heat resistance.

It is possible to give, as glass having chemical durability, large rigidity, and a high thermal expansion coefficient, glass which contains, in terms of oxides expressed in mol %:
1) 50 to 75% of SiO₂;
2) 0 to 15% of Al₂O₃;
3) 3 to 35% in total of at least one kind of metal oxide selected from Li₂O, Na₂O, and K₂O;
4) 0 to 35% in total of at least one kind of metal oxide selected from MgO, CaO, SrO, BaO, and ZnO; and
5) 0 to 15% in total of at least one kind of metal oxide selected from ZrO₂, TiO₂, La₂O₃, Y₂O₃, Ta₂O₅, Nb₂O₅, and HfO₂.

Note that it is desirable to add Sn oxide and Ce oxide at a total content in terms of outer percentage in the range of 0.1 to 3.5 mass % in order to improve bubble removal at the time of fining. In this case, the mass ratio of the content of Sn oxide to the total content of Sn oxide and Ce oxide (mass of Sn oxide/(mass of Sn oxide+mass of Ce oxide)) is 0.01 to 0.99. Hereinafter, unless otherwise specified, the content and total content of glass components are expressed in mol %, but the contents of Sn oxide and Ce oxide are expressed in mass %.

SiO₂, which is a component for forming a glass network, is an essential component that functions so as to improve glass stability and chemical durability, in particular, acid resistance. When the content of SiO₂ is less than 50%, the above-mentioned functions cannot be sufficiently provided. When the content of SiO₂ exceeds 75%, undissolved substances may occur in the glass or bubble removal may become insufficient because the viscosity of the glass at the time of fining becomes too high. Thus, the content of SiO₂ is preferably 50 to 75%.

Al₂O₃ also contributes to forming a glass network, functions so as to improve glass stability and chemical durability, and also functions so as to increase an ion exchange rate at the time of chemical strengthening. When the content of Al₂O₃ exceeds 15%, the meltability of the glass lowers and undissolved substances may be liable to occur. Moreover, the thermal expansion coefficient may lower and the Young's modulus may lower. Thus, the content of Al₂O₃ is preferably 0 to 15%.

Li₂O, Na₂O, and K₂O each function so as to improve the meltability and moldability of the glass, and also function so as to increase the thermal expansion coefficient of the glass. When the content of Li₂O, Na₂O, and K₂O is less than 3%, the above-mentioned functions may not be sufficiently provided. When the content exceeds 35%, chemical durability, in particular, acid resistance maybe lowered, or the thermal stability of the glass may be lowered. Further, a glass transition temperature maybe lowered, thereby lowering heat resistance as well. Accordingly, the content of Li₂O, Na₂O, and K₂O is preferably 3 to 35%, more preferably 5 to 35%. It should be noted that, out of Li₂O, Na₂O, and K₂O, Li₂O has the greatest function of lowering a glass transition temperature.

MgO, CaO, SrO, BaO, and ZnO each function so as to improve the meltability, moldability, and Young's modulus of the glass, and also function so as to increase the thermal expansion coefficient and Young's modulus of the glass. However, when the total content of MgO, CaO, SrO, BaO, and ZnO exceeds 35%, chemical durability or the thermal stability of the glass may be lowered. Accordingly, the total content of MgO, CaO, SrO, BaO, and ZnO is preferably 0 to 35%.

ZrO₂, TiO₂, La₂O₃, Y₂O₃, Ta₂O₅, Nb₂O₅, and HfO₂ each function so as to improve chemical durability, in particular, alkali resistance, improve heat resistance by enhancing a glass transition temperature, and enhance a Young's modulus and fracture toughness. However, when the total content of ZrO₂, TiO₂, La₂O₃, Y₂O₃, Ta₂O₅, Nb₂O₅, and HfO₂ exceeds 15%, the meltability of the glass may be lowered. As a result, an unmelted glass raw material may remain in the glass. Accordingly, the total content of ZrO₂, TiO₂, La₂O₃, Y₂O₃, Ta₂O₅, Nb₂O₅, and HfO₂ is preferably 0 to 15%.

Composition ranges included in the above-mentioned composition range are given below. Note that the content and total content of glass components are expressed in mol %, unless otherwise specified.

First glass, in which importance is given to efficiency of chemical strengthening, has a composition range of
1) the content of SiO₂: 60 to 75%,
2) the content of Al₂O₃: 3 to 12%,
3) the total content of at least one kind of metal oxide selected from Li₂O, Na₂O, and K₂O: 20 to 35% (preferably 20 to 30%),
4) the total content of at least one kind of metal oxide selected from MgO, CaO, SrO, BaO, and ZnO: 0 to 5%, and
5) the total content of at least one kind of metal oxide selected from ZrO₂, TiO₂, La₂O₃, Y₂O₃, Yb₂O₃, Ta₂O₅, Nb₂O₅, and HfO₂: 0 to 7%.

Second glass, in which importance is given to chemical durability, has a composition range of
1) the content of SiO₂: 60 to 75%,
2) the content of Al₂O₃: 1 to 15%,
3) the total content of at least one kind of metal oxide selected from Li₂O, Na₂O, and K₂O: 15 to 25%,
4) the total content of at least one kind of metal oxide selected from MgO, CaO, SrO, BaO, and ZnO: 1 to 6%, and
5) the total content of at least one kind of metal oxide selected from ZrO₂, TiO₂, La₂O₃, Y₂O₃, Yb₂O₃, Ta₂O₅, Nb₂O₅, and HfO₂: 0.1 to 9% (preferably 0.5 to 9%, more preferably 1 to 9%).

Third glass, in which importance is given to large rigidity, has a composition range of
1) the content of SiO₂: 50 to 70%,
2) the content of Al₂O₃: 1 to 8%,
3) the total content of at least one kind of metal oxide selected from Li₂O, Na₂O, and K₂O: 12 to 22%,
4) the total content of at least one kind of metal oxide selected from MgO, CaO, SrO, BaO, and ZnO: 10 to 20%, and
5) the total content of at least one kind of metal oxide selected from ZrO₂, TiO₂, La₂O₃, Y₂O₃, Yb₂O₃, Ta₂O₅, Nb₂O₅, and HfO₂: 3 to 10%.

Fourth glass, in which importance is given to high heat resistance, has a composition range of
1) the content of SiO₂: 50 to 70%,
2) the content of Al₂O₃: 1 to 10%,
3) the total content of at least one kind of metal oxide selected from Li₂O, Na₂O, and K₂O: 5 to 17% (provided that the content of Li₂O is 0 to 5%, preferably 0 to 1%).
4) the total content of at least one kind of metal oxide selected from MgO, CaO, SrO, BaO, and ZnO: 10 to 25%, and
5) the total content of at least one kind of metal oxide selected from ZrO₂, TiO₂, La₂O₃, Y₂O₃, Yb₂O₃, Ta₂O₅, Nb₂O₅, and HfO₂: 1 to 12%.

Fifth glass, in which importance is given to high heat resistance, large rigidity, and high thermal expansion, has a composition range of
1) the content of SiO₂: 50 to 75%,
2) the content of Al₂O₃: 0 to 5%,
3) the total content of at least one kind of metal oxide selected from Li₂O, Na₂O, and K₂O: 3 to 15% (provided that the content of Li₂O is 0 to 1%),
4) the total content of at least one kind of metal oxide selected from MgO, CaO, SrO, BaO, and ZnO: 14 to 35%, and
5) the total content of at least one kind of metal oxide selected from ZrO₂, TiO₂, La₂O₃, Y₂O₃, Yb₂O₃, Ta₂O₅, Nb₂O₅, and HfO₂: 2 to 9%.

### [Method of Manufacturing Magnetic Recording Medium Substrate]

A method of manufacturing a magnetic recording medium substrate in the first embodiment is characterized in that a magnetic recording medium substrate is produced by at least going through a central hole-forming step of forming a central hole in the central portion of the main surface of a glass blank manufactured by the method of manufacturing a glass blank in the first embodiment and a polishing step of polishing the main surface.

First, scribing is performed on a glass blank produced by the method of manufacturing a glass blank in the first embodiment. Scribing refers to providing cutting lines (line-like flaws) like two concentric circles (an inner concentric circle and an outer concentric circle) with a scriber made of cemented carbide or formed of diamond particles on a surface of a formed glass blank, in order to process the formed glass blank into a ring shape having a predetermined size. Note that a shear mark remaining in the glass blank is localized inside the inner concentric circle. The glass blank having scribed thereon the two concentric circles is partially heated, and the outside portion of the outer concentric circle and the inside portion of the inner concentric circle are removed by virtue of the difference in thermal expansion of glass, thereby yielding a disk-shaped glass having a perfect circle shape and a ring shape. The removal of the inside portion of the inner concentric circle corresponds to the central hole-forming step of forming a central hole, and this processing contributes to removing the shear mark.

When scribe processing is carried out, if the roughness of the main surface of the glass blank is 1 μm or less, cutting lines can be suitably provided by using a scriber. Note that, in the case where the roughness of the main surface of the glass blank exceeds 1 μm, a scriber does not follow the irregularities of the surface and it may become difficult to provide cutting lines uniformly. In this case, after the main surface of the glass blank is made smooth, scribing is performed.

Next, the scribed glass undergoes shape processing. The shape processing includes chamfering (chamfering of an outer peripheral end portion and an inner peripheral end portion). In the chamfering, the outer peripheral end portion and inner peripheral end portion of the ring-shaped glass are chamfered with a diamond grinding stone.

Next, the disk-shaped glass undergoes end surface polishing. In the end surface polishing, the inner peripheral side end surface and outer peripheral side end surface of the disk-shaped glass undergo mirror finish by brush polishing. In this case, there is used a slurry including fine particles of cerium oxide or the like as free abrasive grains. The end surface polishing removes contamination caused by attachment of dust or the like and impair such as damage or flaws on or in the end surfaces of the glass. As a result, precipitation of ions of sodium, potassium, and the like causing corrosion can be prevented from occurring. Next, first polishing is carried out on the main surfaces of the disk-shaped glass. The purpose of the first polishing is to remove flaws and strain remaining in the main surfaces.

A machining allowance removed by the first polishing is, for example, several μm to about 10 μm. In the first polishing step and the second polishing step described below, a double-side polishing apparatus is used. The double-side polishing apparatus is an apparatus for carrying out polishing with polishing pads by relatively moving a disk-shaped glass and the polishing pads.

The double-side polishing apparatus includes a polishing carrier fitting portion having an internal gear and a sun gear which are each rotationally driven at a predetermined rotation rate and also includes an upper surface plate and a lower surface plate which are rotationally driven in opposite directions to each other with the polishing carrier fitting portion being sandwiched by both the plates. On each surface facing a disk-shaped glass of the upper surface plate and lower surface plate, the polishing pads described below are attached. Each polishing carrier fitted so as to be engaged with each of the internal gear and the sun gear performs a planetary gear motion, that is, revolves around the sun gear while spinning.

The each polishing carrier holds a plurality of disk-shaped glasses. The upper surface plate is movable in the vertical direction and presses each polishing pad onto the front and back main surfaces of each disk-shaped glass. Then, while a slurry (polishing liquid) containing polishing abrasive grains (polishing material) is being supplied, the disk-shaped glass and the polishing pad move relatively owning to the planetary gear motion of the polishing carrier and the phenomenon that the upper surface plate and the lower surface plate rotate in opposite directions to each other. As a result, the front and back main surfaces of each disk-shaped glass is polished. Note that, in the first polishing step, a hard resin polisher, for example, is used as the polishing pad and cerium oxide abrasive grains, for example, are used as the polishing material.

Next, the disk-shaped glass after the first polishing is subjected to chemical strengthening. It is possible to use, as a molten salt that is used for the chemical strengthening, for example, a mixed molten salt of potassium nitrate (60 mass %) and sodium nitrate (40 mass %). In the chemical strengthening, the molten salt is heated to, for example, 300° C. to 400° C., and a cleaned disk-like glass is pre-heated to, for example, 200° C. to 300° C. and then immersed in the molten salt for, for example, 3 hours to 4 hours. The immersion is preferably performed under a state in which a plurality of disk-shaped glasses are contained in a holder so as to be held by their end surfaces so that both main surfaces of each of the disk-shaped glasses entirely undergo chemical strengthening.

Each disk-shaped glass is immersed in the molten salt, as described above, and as a result, lithium ions and sodium ions in the surface layers of the disk-shaped glass are substituted by sodium ions and potassium ions each having a relatively large ion radius in the molten salt, respectively, forming a compressive stress layer with a thickness of about 50 to 200 μm. Thus, the disk-shaped glass is strengthened and is provided with good impact resistance. Note that the glass having undergone chemical strengthening treatment is cleaned. For example, the glass is cleaned with sulfuric acid and then cleaned with pure water, isopropyl alcohol (IPA), or the like.

Next, the disk-shaped glass which has undergone chemical strengthening and has been cleaned sufficiently is subjected to second polishing. A machining allowance removed by the second polishing is, for example, about 1 μm. The purpose of the second polishing is to finish the main surfaces like mirror surfaces. In the second polishing step, the disk-shaped glass is polished by using a double-side polishing apparatus as in the first polishing step, but the composition of polishing abrasive grains contained in a polishing liquid (slurry) to be used and the composition of a polishing pad are different from those in the first one. In the second polishing step, there are used polishing abrasive grains each having a smaller diameter and a softer polishing pad compared with those in the first polishing step. For example, in the second polishing step, a soft foamed resin polisher, for example, is used as the polishing pad, and finer cerium oxide abrasive grains than the cerium oxide abrasive grains used in the first polishing step or colloidal silica, for example, is used as the polishing material. The disk-shaped glass polished in the second polishing step is again cleaned. In the cleaning, a neutral detergent, pure water, or IPA is used.

The second polishing yields a glass substrate for a magnetic disk having, for example, a flatness in main surface of 4 μm or less and a roughness in main surface of 0.2 nm or less. After that, various layers such as a magnetic layer are formed on the glass substrate for a magnetic disk, and a magnetic disk is manufactured.

Note that the chemical strengthening step is carried out between the first polishing step and the second polishing step, and the order of these steps is not limited to this order. As long as the second polishing step is carried out after the first polishing step, the chemical strengthening step can be arbitrarily arranged. For example, the order of a) the first polishing step, b) the second polishing step, and c) the chemical strengthening step (hereinafter, referred to as “routing 1” in some cases) will do. Note that if the routing 1 is adopted, surface irregularities that may be produced by the chemical strengthening step are not removed, and hence more preferred is the routing in which a) the first polishing step, b) the chemical strengthening step, and c) the second polishing step are carried out in the stated order.

### [Method of Manufacturing Magnetic Recording Medium]

A method of manufacturing a magnetic recording medium in the first embodiment is characterized in that a magnetic recording medium is produced by at least going through a magnetic recording layer-forming step of forming a magnetic recording layer on a magnetic recording medium substrate manufactured by the method of manufacturing a magnetic recording medium substrate in the first embodiment.

On the main surface of a magnetic recording medium substrate (glass substrate for a magnetic disk) manufactured by the method of manufacturing a magnetic recording medium substrate in the first embodiment, layers such as a magnetic layer are formed, thereby manufacturing a magnetic recording medium (a magnetic disk). For example, from the main surface side of the substrate, an adherent layer, a soft magnetic layer, a non-magnetic undercoat layer, a vertical magnetic recording layer, a protective layer, and a lubricant layer are laminated sequentially. The adherent layer, in which, for example, a Cr alloy is used, functions as an adhesion layer with a glass substrate. In the soft magnetic layer, for example, a CoTaZr alloy is used. In the non-magnetic undercoat layer, for example, a non-magnetic granular layer is used. In the vertical magnetic recording layer, for example, a magnetic granular layer is used. Further, in the protective layer, a material made of hydrogenated carbon is used, and in the lubricant layer, for example, a fluorine-based resin is used.

More specifically, an inline-type sputtering apparatus is used to form sequentially, on both main surfaces of a glass substrate, a CrTi adherent layer, a CoTaZr/Ru/CoTaZr soft magnetic layer, a CoCrSiO₂ non-magnetic granular undercoat layer, a CoCrPt—SiO₂.TiO₂ magnetic granular layer, and a hydrogenated carbon protective layer. Besides, a perfluoropolyether lubricant layer is formed on the formed uppermost layer by a dip method, yielding a magnetic recording medium (magnetic disk).

### Second Embodiment

### [Method of Manufacturing Glass Blank]

A method of manufacturing a glass blank in the second embodiment includes separating a molten glass gob from a molten glass flow flowing out from a glass outlet and press-molding the molten glass gob into a thin flat glass by using press molds, thereby manufacturing a glass blank to be processed into a magnetic recording medium substrate having a central hole, in which the molten glass gob is separated and falls, and the molten glass gob in the air is pressed with press-molding surfaces facing each other, thereby molding the molten glass gob into the thin flat glass, and the direction of the molten glass gob is changed so that the site at which the molten glass gob is separated from the molten glass flow faces one of the press-molding surfaces, followed by the start of the pressing.

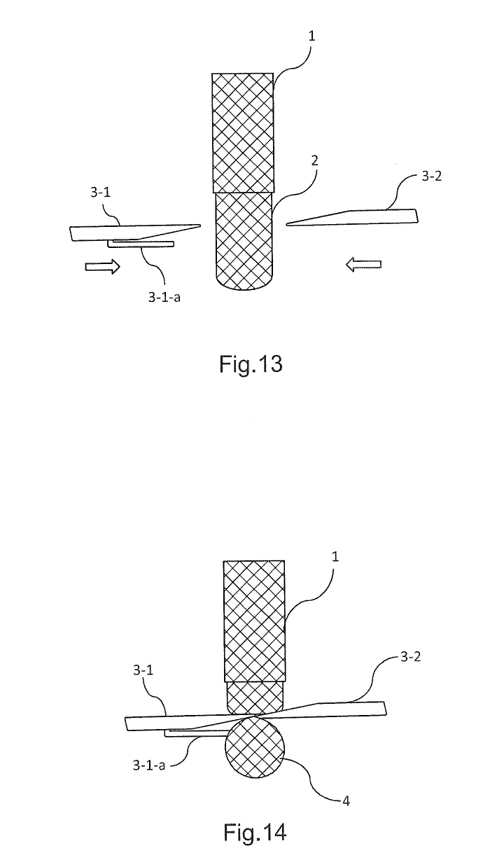

The method of manufacturing a glass blank in the second embodiment is hereinafter described with reference to the drawings. FIG. 13 illustrates how a molten glass flow 2 flowing out from a glass outlet opening at the lower end of a glass effluent pipe 1 falls in the air. The molten glass flow 2 is cut by causing the tips of a pair of shear blades 3-1 and 3-2 to cross each other, thereby shearing glass. The lower surface of the shear blade 3-1 has a projection 3-1-a for applying a torque for turning to a molten glass gob by pushing its upper portion from the horizontal direction. The length in the horizontal direction of the projection 3-1-a is adjustable. The viscosity of out flowing molten glass is controlled by adjusting the temperature of the glass effluent pipe 1 so as to be kept constant in the range of 500 dPa·s to 1,050 dPa·s.

FIG. 14 illustrates an appearance of the moment of cutting a lower portion of the molten glass flow 2 by causing the tips of the shear blades 3-1 and 3-2 to cross each other so as not to produce a gap, thereby separating a molten glass gob 4. The projection 3-1-a applies a torque for turning the molten glass gob 4 clockwise by pushing an upper portion of the molten glass gob 4 from the horizontal direction immediately after the separation of the molten glass gob 4. Note that it may also be possible to adopt a structure that the projection 3-1-a is separated from the shear blade, and the separated projection 3-1-a applies a torque for turning the molten glass gob 4 by pushing an upper portion of the molten glass gob 4 in the horizontal direction, or causes the molten glass gob 4 to turn clockwise by pushing a lower portion of the molten glass gob 4 in the horizontal direction, in synchronization with the movement of the shear blade 3-1.

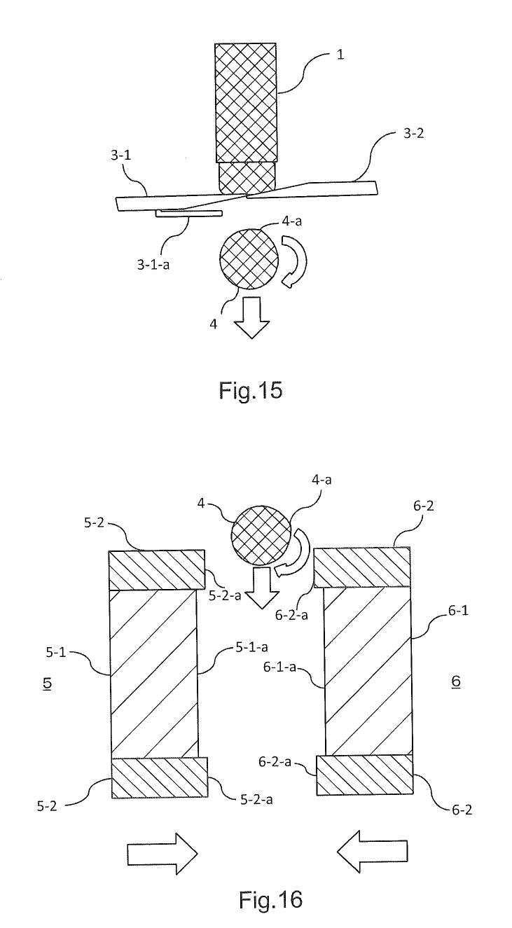

FIG. 15 illustrates how the separated molten glass 4 is falling while turning clockwise. When the molten glass gob 4 is cut and separated, a so-called shear mark 4-a is produced at the peak portion of the molten glass gob 4 by the shear blades, and the shear mark 4-a turns in the clockwise direction simultaneously with the turn of the molten glass gob 4.

FIG. 16 illustrates a vertical cross section of press molds 5 and 6. The press mold 5 includes, for example, a press mold body 5-1 having a press-molding surface 5-1-a and guide members 5-2, which are fitted around the press mold body 5-1 and are used for determining the distance between the press-molding surfaces by abutting the press mold 6 so that the distance between the press-molding surfaces is equal to the thickness of a thin flat glass at the time of press-molding and used for guiding the press mold body 5-1 when the press mold body 5-1 is caused to attach to the main surface of the thin flat glass.

It is preferred to use a metal or an alloy as a material for forming the press mold in view of heat resistance, workability, and durability. In particular, a metal or alloy having a heat resistant temperature of 1,000° C. or more, preferably 1,100° C. or more when used in the press mold is more preferred. Specific examples of the material preferably include ferrum casting ductile (FCD), alloy tool steel (such as SKD61), high-speed steel (SKH), cemented carbide, Colmonoy, and Stellite.

The main surface of the glass blank is molded by transcribing the press-molding surface to glass, and hence the surface roughness of the press-molding surface and the surface roughness of the main surface of the glass blank become substantially the same. The surface roughness of the main surface of the glass blank is desirably controlled to the range of 0.01 to 10 μm in view of performing the scribe processing and grinding processing using a diamond sheet which are described below, and hence the surface roughness of the press-molding surface is also preferably controlled to the range of 0.01 to 10 μm.

The press mold 6 includes, for example, a press mold body 6-1 having a press-molding surface 6-1-a and guide members 6-2, which are fitted around the press mold body 6-1 and are used for determining the distance between the press-molding surfaces by abutting the press mold 5 so that the distance between the press-molding surfaces is equal to the thickness of the thin flat glass at the time of press-molding and used for guiding the press mold body 6-1 when the press mold body 6-1 is caused to attach to the main surface of the thin flat glass.

In FIG. 16, the molten glass gob 4 falls while turning into the space between the press molds 5 and 6 in forward driving to press the molten glass gob 4.

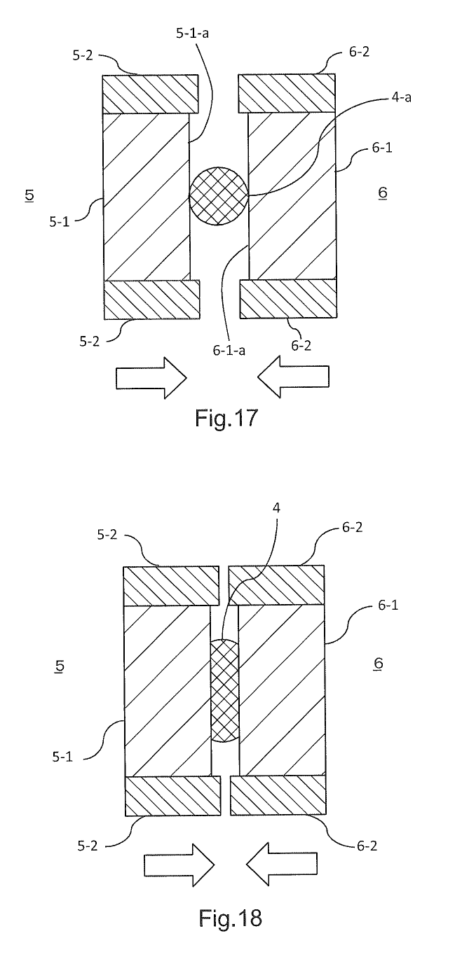

FIG. 17 illustrates the moment at which the press-molding surfaces 5-1-a and 6-1-a start pressing the molten glass gob 4. Here, the shear mark 4-a first comes into contact with the press-molding surface 6-1-a. In order to realize this state, adjusted are the magnitude of a torque for turning the molten glass gob 4 and the falling distance of the molten glass gob 4. The falling distance is controlled to preferably 1,000 mm or less, more preferably 500 mm or less, still more preferably 300 mm or less, yet still more preferably 200 mm or less, in order to prevent the phenomenon that the viscosity of the molten glass gob 4 increases, deviating from the viscosity range suitable for press-molding and in order to prevent the phenomenon that the falling speed becomes too high, fluctuating the position of pressing.

After the surface of the molten glass gob comes into contact with the press-molding surfaces, the surface of the molten glass gob is solidified so as to attach to the press-molding surfaces. When the pressing is further performed, the glass is pressed and spread so as to have a uniform thickness around the positions at which the molten glass gob and the molding surfaces first come into contact, thereby forming the glass into a thin flat glass having a disk shape or a disk-like shape.

FIG. 18 illustrates how the glass is pressed and spread in the above-mentioned pressing process. The shear mark and its neighboring portion first come into contact with the press-molding surface 6-1-a and are solidified so as to attach to the molding surface 6-1-a, and hence the shear mark and its neighboring portion remain in the surface of the central portion of the thin flat glass.

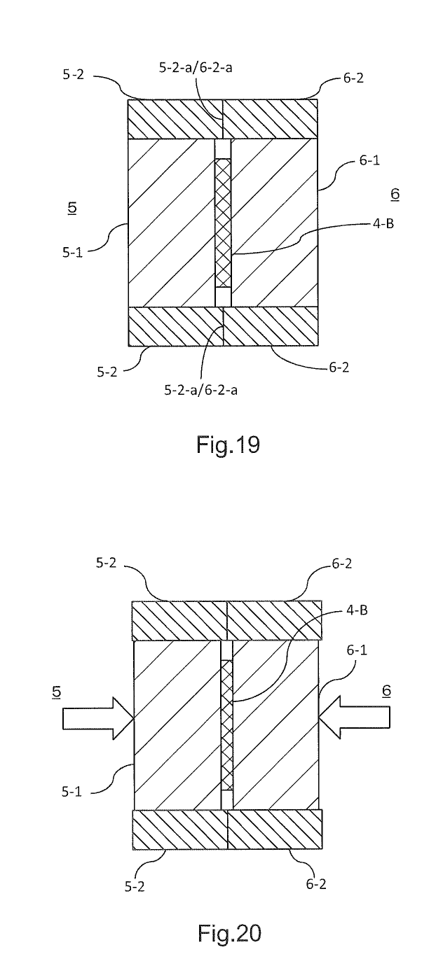

FIG. 19 illustrates a state in which the distance between the press-molding surface 5-1-a and the press-molding surface 6-1-a is matched to a distance corresponding to the thickness of the glass blank by causing an abutting surface 5-2-a of the guide member 5-2 and an abutting surface 6-2-a of the guide member 6-2 to abut each other. The abutting between the abutting surface 5-2-a and the abutting surface 6-2-a also functions to maintain the parallel state between the press-molding surface 5-1-a and the press-molding surface 6-1-a. The time taken from the start of pressing illustrated in FIG. 17 until the mold closing illustrated in FIG. 19 is preferably controlled to 0.1 second or less for the purpose of forming the molten glass gob into a thin flat glass.

In FIG. 20, a pressure that is sufficiently smaller than the press pressure is applied to the press mold bodies 5-1 and 6-1 under a state in which the abutting surface 5-2-a and the abutting surface 6-2-a abut each other so that the press-molding surfaces 5-1-a and 6-1-a are each closely attached to the main surface of the thin flat glass. If the press pressure is increased while this state is being kept, glass may break. While this state is being kept for several seconds, the thin flat glass is cooled.

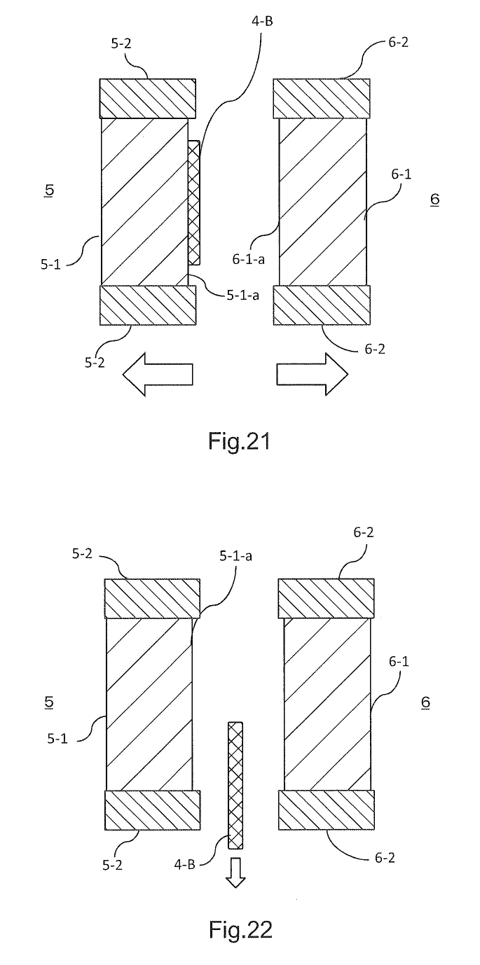

Next, as illustrated in FIG. 21, the press molds 5 and 6 are detached from each other to demold a thin flat glass 4-B from the press-molding surface 6-1-a. Then, as illustrated in FIG. 22, the thin flat glass 4-B is demolded from the press-molding surface 5-1-a and is taken out. When the thin flat glass 4-B is demolded from the press-molding surface 5-1-a, if the thin flat glass 4-B is demolded as if peeling it by applying a force from an outer peripheral direction of the thin flat glass 4-B, the thin flat glass 4-B can be taken out from the press-molding surface 5-1-a without applying a large force to the thin flat glass 4-B.

The thin flat glass taken out is subjected to annealing to reduce or remove strain, thereby providing a base material to be processed into a magnetic recording medium substrate, that is, a glass blank. The glass blank locally includes a shear mark in the center of its main surface. Thus, a region including the shear mark can be removed by the central hole-forming step at the time of manufacturing a substrate.

Note that, when the viscosity of molten glass is less than 500 dPa·s, it becomes difficult to separate the molten glass gob in a necessary amount in a state in which a molten glass flow is falling in the air. When the molten glass having a viscosity of less than 500 dPa·s at the time of outflow is used, it is recommended that a necessary amount of the molten glass for obtaining the molten glass gob be accumulated by supporting the lower end of the molten glass flow below the glass outlet, the molten glass gob be then separated, the molten glass gob be caused to fall by applying a torque for turning, and pressing be started after the position of a shear mark is adjusted so that the shear mark faces one of the press-molding surfaces.

By subjecting the molten glass gob that is falling to press-molding, the viscosity distribution of the molten glass gob just before the start of the press-molding is made uniform, and the glass can be stretched more easily so as to have a uniform, small thickness. When the inner diameter of the central hole formed in the substrate is small, the size of the shear mark is made smaller so that the shear mark is located in the range in which the central hole is formed.

Specifically, the cross-sectional shape of a falling molten glass flow is controlled so that the molten glass flow has an elongated shape in the horizontal cross section, that is, has a cross-sectional shape with a major axis and a minor axis. For example, the cross-sectional shape of the molten glass flow is made elongated by modifying the shape of the glass outlet to an elongated one, or the cross-sectional shape is made elongated by sandwiching the sides of the molten glass flow from two directions opposite to each other. Then, the molten glass flow is cut in the major axis direction by using shear blades. Because the molten glass flow is sheared in the major axis direction, the shear mark can be made smaller. Thus, even in the case where the inner diameter of the central hole of a substrate is small, the shear mark can be localized in the area in which the central hole is formed. As a technique for making a shear mark smaller, a method involving cutting a molten glass flow by causing a pair of shear blades in which cutting blades each have a V shape or a U shape to cross each other is also effective.

According to the method described above, there can be produced a glass blank having a thickness deviation of 10 μm or less and a flatness of 10 μm or less. The preferred range of the flatness of the glass blank is 8 μm or less, the more preferred range is 6 μm or less, and the still more preferred range is 4 μm or less.

The method of manufacturing a glass blank in the second embodiment is suitable for producing a glass blank having a ratio of diameter to thickness (diameter/thickness) of 50 to 150. Here, the diameter refers to an arithmetic average of the major axis and minor axis of the glass blank. The press molds do not regulate the outer peripheral surface of the glass blank, and hence the outer peripheral surface is a free surface, and the circularity of the glass blank that is molded is within ±0.5 mm.

The diameter of the glass blank is not particularly limited. The diameter is preferably set, as a target value, to a value obtained by adding, to the diameter of the substrate, the amount of glass that is removed at the time of scribe processing and outer peripheral processing which are carried out when the glass blank is processed into a magnetic recording medium substrate, as described below.

The thickness of the glass blank falls within the range of 0.75 to 1.1 mm, preferably within the range of 0.75 to 1.0 mm, more preferably within the range of 0.90 to 0.92 mm. It is recommended to measure the thickness, thickness deviation, flatness, diameter, and circularity of the glass blank by using a three-dimensional measuring machine and a micrometer.

It is recommended that the composition of glass to be used be appropriately selected depending on the properties that are required for a magnetic recording medium substrate. Examples of the glass include alumino silicate glass, soda lime glass, soda alumino silicate glass, and alumino borosilicate glass. Further, these kinds of glass may be crystallized glass, which is crystallized by heat treatment, and can be crystallized by heat treatment and then processed into a substrate.

Glass used for a substrate of a magnetic recording medium such as a magnetic disk desirably has chemical durability, large rigidity, and a high thermal expansion coefficient. Further, when importance is given to enhancing bending strength, the glass is required to have a composition that is suitable for undergoing chemical strengthening, and when high-temperature heat treatment is carried out in a process of producing a magnetic recording medium, the glass is desired to have a composition that is suitable for exhibiting good heat resistance.

It is possible to give, as glass having chemical durability, large rigidity, and a high thermal expansion coefficient, glass which contains, in terms of oxides expressed in mol %:
50 to 75% of SiO₂;
0 to 15% of Al₂O₃;
3 to 35% in total of Li₂O, Na₂O, and K₂O;
0 to 35% in total of MgO, CaO, SrO, BaO, and ZnO; and
0 to 15% in total of ZrO₂, TiO₂, La₂O₃, Y₂O₃, Ta₂O₅, Nb₂O₅, and HfO₂.

Note that it is desirable to add Sn oxide and Ce oxide at a total content in terms of outer percentage of 0.1 to 3.5 mass % in order to improve bubble removal at the time of fining. In this case, the mass ratio of the content of Sn oxide to the total content of Sn oxide and Ce oxide (mass of Sn oxide/(mass of Sn oxide+mass of Ce oxide)) is 0.01 to 0.99. Hereinafter, unless otherwise specified, the content and total content of glass components are expressed in mol %, but the contents of Sn oxide and Ce oxide are expressed in mass %.

SiO₂, which is a component for forming a glass network, is an essential component that functions so as to improve glass stability and chemical durability, in particular, acid resistance. When the content of SiO₂ is less than 50%, the above-mentioned functions cannot be sufficiently provided. When the content of SiO₂ exceeds 75%, undissolved substances occurs in the glass or bubble removal becomes insufficient because the viscosity of the glass at the time of fining becomes too high. Thus, the content of SiO₂ is preferably 50 to 75%.

Al₂O₃ also contributes to forming a glass network, functions so as to improve glass stability and chemical durability, and also functions so as to increase an ion exchange rate at the time of chemical strengthening. When the content of Al₂O₂ exceeds 15%, the meltability of the glass lowers and undissolved substances are liable to occur. Moreover, the thermal expansion coefficient may lowers and the Young's modulus also lowers. Thus, the content of Al₂O₃ is preferably 0 to 15%.

Li₂O, Na₂O, and K₂O each function so as to improve the meltability and moldability of the glass, and also function so as to increase the thermal expansion coefficient of the glass. When the content of Li₂O, Na₂O, and K₂O is less than 3%, the above-mentioned functions are not sufficiently provided. When the content exceeds 35%, chemical durability, in particular, acid resistance is lowered, or the thermal stability of the glass is lowered. Further, a glass transition temperature is lowered, thereby lowering heat resistance as well. Accordingly, the content of Li₂O, Na₂O, and K₂O is preferably 3 to 35%, more preferably 5 to 35%. It should be noted that, out of Li₂O, Na₂O, and K₂O, Li₂O has the greatest function of lowering a glass transition temperature.

MgO, CaO, SrO, BaO, and ZnO each function so as to improve the meltability, moldability, and Young's modulus of the glass, and also function so as to increase the thermal expansion coefficient and Young's modulus of the glass. However, when the total content of MgO, CaO, SrO, BaO, and ZnO exceeds 35%, chemical durability or the thermal stability of the glass is lowered. Accordingly, the total content of MgO, CaO, SrO, BaO, and ZnO is preferably 0 to 35%.

ZrO₂, TiO₂, La₂O₃, Y₂O₃, Ta₂O₅, Nb₂O₅, and HfO₂ each function so as to improve chemical durability, in particular, alkali resistance, improve heat resistance by enhancing a glass transition temperature, and enhance a Young's modulus and fracture toughness. However, when the total content of ZrO₂, TiO₂, La₂O₃, Y₂O₃, Ta₂O₅, Nb₂O₅, and HfO₂ exceeds 15%, the meltability of the glass is lowered. As a result, an unmelted glass raw material remains in the glass. Accordingly, the total content of ZrO₂, TiO₂, La₂O₃, Y₂O₃, Ta₂O₅, Nb₂O₅, and HfO₂ is preferably 0 to 15%.

Composition ranges included in the above-mentioned composition range are given below. Note that the content and total content of glass components are expressed in mol %, unless otherwise specified.

First glass, in which importance is given to efficiency of chemical strengthening, has a composition range of
the content of SiO₂: 60 to 75%,
the content of Al₂O₂: 3 to 12%,
the total content of Li₂O, Na₂O, and K₂O: 20 to 35% (preferably 23 to 35%),
the total content of MgO, CaO, SrO, BaO, and ZnO: 0 to 5%, and
the total content of ZrO₂, TiO₂, La₂O₃, Y₂O₃, Yb₂O₃, Ta₂O₅, Nb₂O₅, and HfO₂: 0 to 7%.

Second glass, in which importance is given to chemical durability, has a composition range of
the content of SiO₂: 60 to 75%,
the content of Al₂O₂: 1 to 15%,
the total content of Li₂O, Na₂O, and K₂O: 15 to 25%,
the total content of MgO, CaO, SrO, BaO, and ZnO: 1 to 6%, and
the total content of ZrO₂, TiO₂, La₂O₃, Y₂O₃, Yb₂O₃, Ta₂O₅, Nb₂O₅, and HfO₂: 0.1 to 9% (preferably 0.5 to 9%, more preferably 1 to 9%).

Third glass, in which importance is given to large rigidity, has a composition range of
the content of SiO₂: 50 to 70%,
the content of Al₂O₂: 1 to 8%,
the total content of Li₂O, Na₂O, and K₂O: 12 to 22%,
the total content of MgO, CaO, SrO, BaO, and ZnO: 10 to 20%, and
the total content of ZrO₂, TiO₂, La₂O₃, Y₂O₃, Yb₂O₃, Ta₂O₅, Nb₂O₅, and HfO₂: 3 to 10%.

Fourth glass, in which importance is given to high heat resistance, has a composition range of
the content of SiO₂: 50 to 70%,
the content of Al₂O₂: 1 to 10%,
the total content of Li₂O, Na₂O, and K₂O: 5 to 17% (in which the content of LiO₂ is 0 to 5%, preferably 0 to 1%),
the total content of MgO, CaO, SrO, BaO, and ZnO: 10 to 25%, and
the total content of ZrO₂, TiO₂, La₂O₃, Y₂O₃, Yb₂O₃, Ta₂O₅, Nb₂O₅, and HfO₂: 1 to 12%.

Fifth glass, in which importance is given to high heat resistance, large rigidity, and high thermal expansion, has a composition range of
the content of SiO₂: 50 to 75%,
the content of Al₂O₂: 0 to 5%,
the total content of Li₂O, Na₂O, and K₂O: 3 to 15% (in which the content of LiO₂ is 0 to 1%),
the total content of MgO, CaO, SrO, BaO, and ZnO: 14 to 35%, and
the total content of ZrO₂, TiO₂, La₂O₃, Y₂O₃, Yb₂O₃, Ta₂O₅, Nb₂O₅, and HfO₂: 2 to 9%.

### [Method of Manufacturing Magnetic Recording Medium Substrate]

A method of manufacturing a magnetic recording medium substrate in the second embodiment is characterized in that a magnetic recording medium substrate is produced by at least going through a polishing step of polishing the main surface of a glass blank manufactured by the method of manufacturing a glass blank in the second embodiment and a hole-forming step of forming a central hole in the central portion of the main surface.

First, scribing is performed on a glass blank obtained by press-molding. Scribing refers to providing cutting lines (line-like flaws) like two concentric circles (an inner concentric circle and an outer concentric circle) with a scriber made of cemented carbide or formed of diamond particles on a surface of a formed glass blank, in order to process the formed glass blank into a ring shape having a predetermined size. Note that a shear mark remaining in the glass blank is localized inside the inner concentric circle. The glass blank having scribed thereon the two concentric circles is partially heated, and the outside portion of the outer concentric circle and the inside portion of the inner concentric circle are removed by virtue of the difference in thermal expansion of glass, thereby yielding a disk-shaped glass having a perfect circle shape. The removal of the inside portion of the inner concentric circle corresponds to the central hole-forming processing, and this processing contributes to removing the shear mark.

The roughness of the main surface of the glass blank is 1 μm or less, and hence cutting lines can be suitably provided by using a scriber. Note that, in the case where the roughness of the main surface of the glass blank exceeds 1 μm, a scriber does not follow the irregularities of the surface and cutting lines cannot be provided uniformly. Accordingly, after the main surface of the glass blank is made smooth, scribing is performed.

Next, the scribed glass undergoes shape processing. The shape processing includes chamfering (chamfering of an outer peripheral end portion and an inner peripheral end portion). In the chamfering, the outer peripheral end portion and inner peripheral end portion of the ring-shaped glass are chamfered with a diamond grinding stone.

Next, the disk-shaped glass undergoes end surface polishing. In the end surface polishing, the inner peripheral side end surface and outer peripheral side end surface of the glass undergo mirror finish by brush polishing. In this case, there is used a slurry including fine particles of cerium oxide or the like as free abrasive grains. The end surface polishing removes contamination caused by attachment of dust or the like and impair such as damage or flaws on or in the end surfaces of the glass. As a result, precipitation of ions of sodium, potassium, and the like causing corrosion can be prevented from occurring. Next, first polishing is carried out on the main surfaces of the disk-shaped glass. The purpose of the first polishing is to remove flaws and strain remaining in the main surfaces.

A machining allowance removed by the first polishing is, for example, several μm to about 10 μm. A grinding step removing a large machining allowance is not required, and hence a flaw, strain, or the like due to the grinding step is not generated in the glass. Accordingly, the machining allowance in the first polishing step is small. In the first polishing step and the second polishing step described below, a double-side polishing apparatus is used. The double-side polishing apparatus is an apparatus for carrying out polishing with polishing pads by relatively moving a disk-shaped glass and the polishing pads.

The double-side polishing apparatus includes a polishing carrier fitting portion having an internal gear and a sun gear which are each rotationally driven at a predetermined rotation rate and also includes an upper surface plate and a lower surface plate which are rotationally driven in opposite directions to each other with the polishing carrier fitting portion being sandwiched by both the plates. On each surface facing a disk-shaped glass of the upper surface plate and lower surface plate, the polishing pads described below are attached. Each polishing carrier fitted so as to be engaged with each of the internal gear and the sun gear performs a planetary gear motion, that is, revolves around the sun gear while spinning.

The each polishing carrier holds a plurality of disk-shaped glasses. The upper surface plate is movable in the vertical direction and presses each polishing pad onto the front and back main surfaces of each disk-shaped glass. Then, while a slurry (polishing liquid) containing polishing abrasive grains (polishing material) is being supplied, the disk-shaped glass and the polishing pad move relatively owning to the planetary gear motion of the polishing carrier and the phenomenon that the upper surface plate and the lower surface plate rotate in opposite directions to each other. As a result, the front and back main surfaces of each disk-shaped glass is polished. Note that, in the first polishing step, a hard resin polisher, for example, is used as the polishing pad and cerium oxide abrasive grains, for example, are used as the polishing material.

Next, the disk-shaped glass after the first polishing is subjected to chemical strengthening. It is possible to use, as a the chemical strengthening solution, for example, a mixed solution of potassium nitrate (60%) and sodium nitrate (40%). In the chemical strengthening, the chemical strengthening solution is heated to, for example, 300° C. to 400° C., and a cleaned glass is pre-heated to, for example, 200° C. to 300° C. and then immersed in the chemical strengthening solution for, for example, 3 hours to 4 hours. The immersion is preferably performed under a state in which a plurality of glasses are contained in a holder so as to be held by their end surfaces so that both main surfaces of each of the glasses entirely undergo chemical strengthening.

Each glass is immersed in the chemical strengthening solution, as described above, and as a result, lithium ions and sodium ions in the surface layers of the glass are substituted by sodium ions and potassium ions each having a relatively large ion radius in the chemical strengthening solution, respectively, forming a compressive stress layer with a thickness of about 50 to 200 μm. Thus, the glass is strengthened and is provided with good impact resistance. Note that the glass having undergone chemical strengthening treatment is cleaned. For example, the glass is cleaned with sulfuric acid and then cleaned with pure water, isopropyl alcohol (IPA), or the like.

Next, the glass which has undergone chemical strengthening and has been cleaned sufficiently is subjected to second polishing. A machining allowance removed by the second polishing is, for example, about 1 μm. The purpose of the second polishing is to finish the main surfaces like mirror surfaces. In the second polishing step, the disk-shaped glass is polished by using a double-side polishing apparatus as in the first polishing step, but the composition of polishing abrasive grains contained in a polishing liquid (slurry) to be used and the composition of a polishing pad are different from those in the first one. In the second polishing step, there are used polishing abrasive grains each having a smaller diameter and a softer polishing pad compared with those in the first polishing step. For example, in the second polishing step, a soft foamed resin polisher, for example, is used as the polishing pad, and finer cerium oxide abrasive grains than the cerium oxide abrasive grains used in the first polishing step, for example, are used as the polishing material. The disk-shaped glass polished in the second polishing step is again cleaned. In the cleaning, a neutral detergent, pure water, or IPA is used.

The second polishing yields a glass substrate for a magnetic disk having a flatness in main surface of 4 μm or less and a roughness in main surface of 0.2 nm or less. After that, various layers such as a magnetic layer are formed on the glass substrate for a magnetic disk, and a magnetic disk is manufactured.

Note that the chemical strengthening step is carried out between the first polishing step and the second polishing step, and the order of these steps is not limited to this order. As long as the second polishing step is carried out after the first polishing step, the chemical strengthening step can be arbitrarily arranged. For example, the order of the first polishing step, the second polishing step, and the chemical strengthening step (hereinafter, referred to as “routing 1”) will do. Note that if the routing 1 is adopted, surface irregularities that may be produced by the chemical strengthening step are not removed, and hence more preferred is the routing of the first polishing step, the chemical strengthening step, and the second polishing step in the stated order.

### [Method of Manufacturing Magnetic Recording Medium]

A method of manufacturing a magnetic recording medium in the second embodiment is characterized in that a magnetic recording medium is produced by at least going through a magnetic recording layer-forming step of forming a magnetic recording layer on a magnetic recording medium substrate manufactured by the method of manufacturing a magnetic recording medium substrate in the second embodiment.

On the main surface of a magnetic recording medium substrate (glass substrate for a magnetic disk) manufactured by the method described above, layers such as a magnetic layer are formed, thereby manufacturing a magnetic recording medium a magnetic disk). For example, from the main surface side of the substrate, an adherent layer, a soft magnetic layer, a non-magnetic undercoat layer, a vertical magnetic recording layer, a protective layer, and a lubricant layer are laminated sequentially. The adherent layer, in which, for example, a Cr alloy is used, functions as an adhesion layer with a glass substrate. In the soft magnetic layer, for example, a CoTaZr alloy is used. In the non-magnetic undercoat layer, for example, a non-magnetic granular layer is used. In the vertical magnetic recording layer, for example, a magnetic granular layer is used. Further, in the protective layer, a material made of hydrogenated carbon is used, and in the lubricant layer, for example, a fluorine-based resin is used.

More specifically, an inline-type sputtering apparatus is used to form sequentially, on both main surfaces of a glass substrate, a CrTi adherent layer, a CoTaZr/Ru/CoTaZr soft magnetic layer, a CoCrSiO₂ non-magnetic granular undercoat layer, a CoCrPt—SiO₂.TiO₂ magnetic granular layer, and a hydrogenated carbon protective layer. Besides, a perfluoropolyether lubricant layer is formed on the formed uppermost layer by a dip method, yielding a magnetic recording medium (magnetic disk).

### EXAMPLES

### EXAMPLES OF FIRST ASPECT OF THE PRESENT INVENTION

Hereinafter, the first aspect of the present invention is described in more detail based on examples, but the first aspect of the present invention is not limited to the following examples.

### Example 1

### —Manufacture and Evaluation of Glass Blank—

Materials such as oxides, carbonates, nitrates, and hydroxides were weighed and mixed enough, yielding each blended material, so that glass having each of the compositions listed in Table 1 is obtained. The blended material was fed into a melting tank in a glass melting furnace, was heated, and was melt. The resultant molten glass was transferred from the melting tank to a fining tank, and bubbles were removed in the fining tank. Further, the molten glass was transferred to an operation tank, was stirred and homogenized in the operation tank, and was caused to flow out from a glass effluent pipe provided in the bottom portion of the operation tank. The melting tank, the fining tank, the operation tank, and the glass effluent pipe were each under temperature control, and in the each tank and the glass effluent pipe, the temperature and viscosity of the molten glass were each controlled in a predetermined range. The molten glass flowing out from the glass effluent pipe was cast into a mold and molded into glass. The resultant glass was used as a sample to measure its glass transition temperature and liquidus temperature. A method of measuring a glass transition temperature and a method of measuring a liquidus temperature are mentioned below.

### (1) Glass Transition Temperature Tg

The glass transition temperature Tg of each glass was measured by using a thermomechanical analyzer (TMA).

### (2) Liquidus Temperature

A glass sample was put in a platinum crucible and kept at a predetermined temperature for 2 hours. After being taken out from the furnace, the glass sample was cooled and the presence or absence of crystal precipitation was observed with a microscope. The lowest temperature at which crystals were not observed was defined as a liquidus temperature (L. T.).

Table 1 shows the glass transition temperature and liquidus temperature of each glass.

TABLE 1

| | | No. 1 | No. 2 | No. 3 | No. 4 | No. 5 | No. 6 |
|---|---|---|---|---|---|---|---|
| Glass | SiO₂ | 66 | 68 | 61 | 64 | 66 | 64 |
| composition | Al₂O₃ | 9 | 9 | 2 | 5 | 0.5 | 5 |
| | Li₂O | 12 | 8 | 14 | 4 | 0 | 1.5 |
| | Na₂O | 10 | 11 | 5 | 6 | 3 | 8.5 |
| | K₂O | 0 | 0.2 | 0 | 1 | 6 | 0 |
| | Li₂O + Na₂O + K₂O | 22 | 19.2 | 19 | 11 | 9 | 10 |
| | MgO | 0 | 1 | 0 | 0 | 6.5 | 4 |
| | CaO | 0 | 1.8 | 13 | 13 | 13 | 13 |
| | SrO | 0 | 0 | 0 | 0 | 0 | 0 |
| | BaO | 0 | 0 | 0 | 3 | 0 | 0 |
| | ZnO | 0 | 0 | 0 | 0 | 0 | 0 |
| | MgO + CaO + SrO + BaO + ZnO | 0 | 2.8 | 13 | 16 | 19.5 | 17 |
| | ZrO₂ | 3 | 1 | 5 | 4 | 5 | 4 |
| | TiO₂ | 0 | 0 | 0 | 0 | 0 | 0 |
| | La₂O₃ | 0 | 0 | 0 | 0 | 0 | 0 |
| | Y₂O₃ | 0 | 0 | 0 | 0 | 0 | 0 |
| | Yb₂O₃ | 0 | 0 | 0 | 0 | 0 | 0 |
| | Ta₂O₅ | 0 | 0 | 0 | 0 | 0 | 0 |
| | Nb₂O₅ | 0 | 0 | 0 | 0 | 0 | 0 |
| | HfO₂ | 0 | 0 | 0 | 0 | 0 | 0 |
| | ZrO₂ + TiO₂ + La₂O₃ + Y₂O₃ + | 3 | 1 | 5 | 4 | 5 | 4 |
| | Ta₂O₅ + Nb₂O₅ + HfO₂ | | | | | | |
| | Total (mol %) | 100 | 100 | 100 | 100 | 100 | 100 |
| | SnO₂ (mass %, outer | 0.6 | 0.6 | 0.6 | 0.6 | 0.6 | 0.6 |
| | percentage) | | | | | | |
| | CeO₂ (mass %, outer | 0.4 | 0.4 | 0.4 | 0.4 | 0.4 | 0.4 |
| | percentage) | | | | | | |
| | SnO₂ + CeO₂ | 1.0 | 1.0 | 1.0 | 1.0 | 1.0 | 1.0 |
| | (mass %, outer percentage) | | | | | | |
| | SnO₂/(SnO₂ + CeO₂) | 0.6 | 0.6 | 0.6 | 0.6 | 0.6 | 0.6 |
| | (mass ratio) | | | | | | |
| Properties | Viscosity (dPa · s) of glass | 650 | 1000 | 50 | 850 | 1050 | 1000 |
| | at 1250° C. | | | | | | |
| | Liquidus temperature (° C.) | 840 | 920 | 1000 | 1080 | 1180 | 1210 |
| | Glass transition | 500 | 505 | 535 | 665 | 700 | 633 |
| | temperature (° C.) | | | | | | |

Glass having each of the glass compositions and properties shown in Table 1 was used and each glass blank was manufactured sequentially. The each glass blank was manufactured by the method illustrated in FIG. 1 to FIG. 11. In this case, the viscosity of a molten glass flow 20 was adjusted so as to be constant in the range of 500 to 1,050 dPa·s.

An elliptical shape having a major axis of 28 mm and a minor axis of 8 mm was adopted as the shape of the aperture of a glass outlet 12. Cutting of the molten glass flow 20 was performed by shearing a falling molten glass flow 20 in the direction parallel to the major axis of the glass outlet 12 with a pair of shear blades 30 and 40 in which blade portions 34 and 44 each had a V shape. Further, press mold bodies 52 and 62 and guide members 54 and 64 both forming press molds 50 and 60, respectively, were each made of cast iron (FCD).

Next, after the falling distance was fixed to 150 mm, a high-speed camera was used to monitor how a molten glass gob 24 was falling. Further, the driving timing of the shear blades 30 and 40 and the driving timing of the press molds 50 and 60 were adjusted so that press-molding was able to be carried out under a state in which a separation mark 24A faced a molding surface. Then, after such conditions were set, press-molding was carried out. Note that the time taken from the start of pressing as illustrated in FIG. 7 until a state in which the guide surface 54A and the guide surface 64A completely came into contact as illustrated in FIG. 9 was controlled to 0.1 second or less, and press pressure was set to about 6.7 MPa. Next, while the state illustrated in FIG. 9 was being maintained, the press pressure was reduced, and while a state in which the molding surfaces 52A and 62A were closely attached to a thin flat glass 26 was being kept, the thin flat glass 26 was cooled for several seconds. Although the thin flat glass 26 contracted in the cooling process, while the press molds 50 and 60 were caused to follow the contract of the thin flat glass 26 so that the contact between the glass and the press-molding surfaces 52A and 62A were maintained, the thin flat glass 26 were cooled. Next, the press pressure was released and the first press mold 50 and the second press mold 60 were detached from each other as illustrated in FIG. 10 and FIG. 11, to thereby demold and take out the thin flat glass 26, that is, a glass blank.

The diameter, circularity, thickness, thickness deviation, and flatness of each resultant glass blank were measured by using a three-dimensional measuring machine and a micrometer. As a result, in any of the glass blanks made of glass No. 1 to No. 6 shown in Table 1, the diameter was 75 mm, the circularity was within ±0.5 mm, the thickness was 0.90 mm, the thickness deviation was 10 μm or less, and the flatness was 4 μm or less. Note that the above-mentioned measurement results yielded a diameter/thickness ratio of 83.3.

In addition, the main surfaces of the each resultant glass blank were observed to find a shear mark in the central portion of one of the main surfaces. The shear mark was localized in a circle with a radius of 15 mm at the center of each glass blank, and it was found that the shear mark was able to be removed completely when a central hole with an inner diameter of 20 mm was formed at the time of manufacturing a magnetic recording medium substrate. Note that the resultant glass blank was annealed to reduce or remove strain.

Note that a high-speed camera was used to take images of the process from the end of the formation of the molten glass gob 24 until the completion of the press-molding. As a result, it was confirmed that the molten glass gob 24 turned by 90° during falling, and the separation mark 24A which had been positioned in an upper surface of the molten glass gob 24 immediately after its separation with a pair of the shear blades 30 and 40 was brought into contact with the molding surface 62A earlier than any of the portions in the surface of the molten glass gob 24 at the time of the start of press-molding exemplified in FIG. 7.

### —Manufacture and Evaluation of Magnetic Recording Medium Substrate—

The glass blank manufactured was used to apply scribe processing on a portion serving as an outer periphery of a magnetic recording medium substrate and a portion serving as a central hole thereof. As a result of the processing, two grooves looking like concentric circles were formed outside and inside. Next, by partially heating the portions in which the scribe processing was applied, cracks were caused to occur along the each groove produced by the scribe processing, by virtue of the difference in thermal expansion of glass, and the outside portion and inside portion of the outer concentric circle were removed. As a result, a disk-shaped glass having a perfect circle shape and a ring shape was obtained, and the processing completely removed a shear mark.

Next, shape processing was applied to the disk-shaped glass by using chamfering or the like and its end surfaces were polished. Then, after a first polishing was carried out on the main surfaces of the disk-shaped glass, the glass was immersed in a molten salt to perform chemical strengthening.

After the chemical strengthening, the disk-shaped glass was sufficiently cleaned and then subjected to a second polishing. After the second polishing process, the disk-shaped glass was cleaned again and a magnetic recording medium substrate was manufactured. The magnetic recording medium substrate had an outer diameter of 65 mm, a central hole diameter of 20 mm, a thickness of 0.8 mm, a main surface flatness of 4 μm or less, and a main surface roughness of 0.2 nm or less.

### —Manufacture and Evaluation of Magnetic Recording Medium—

On both main surfaces of the magnetic recording medium substrate manufactured, an inline-type sputtering apparatus was used to form sequentially a CrTi adherent layer, a CoTaZr/Ru/CoTaZr soft magnetic layer, a CoCrSiO₂ non-magnetic granular undercoat layer, a CoCrPt—SiO₂.TiO₂ magnetic granular layer, and a hydrogenated carbon protective layer, and then, a perfluoropolyether lubricant layer was formed on the uppermost layer by a dip method, yielding a magnetic recording medium (magnetic disk). The thus obtained magnetic disk was incorporated into a hard disk drive, and its movement was checked to find that the magnetic disk had desired performance.

### Comparative Example 1

Each glass blank was manufactured in the same manner as that in Example 1 except that two strike-type blades for cutting molten glass by striking their tips to each other were used to separate a molten glass gob. Note that the above-mentioned strike-type shear blade does not include such a pressing member as provided in the shear blade used in Example 1. The diameter, circularity, thickness, thickness deviation, and flatness of each resultant glass blank were measured by using a three-dimensional measuring machine and a micrometer. As a result, in any of the glass blanks made of glass No. 1 to No. 6 shown in Table 1, the diameter was 75 mm, the circularity was within ±0.5 mm, the thickness was 0.90 mm, the thickness deviation was 10 μm or less, and the flatness was 4 μm or less. Note that the above-mentioned measurement results yielded that the diameter/thickness ratio was 83.3.

In addition, the resultant glass blank was observed to find a shear mark. The shear mark was localized on the outer peripheral end surface and the main surface in the vicinity thereof, and it was found that the shear mark was able to be removed completely when a central hole with an inner diameter of 20 mm was formed at the time of manufacturing a magnetic recording medium substrate. In addition, unless a lapping step was carried out based on a grinding allowance of about 50 μm at the time of manufacturing a magnetic recording medium substrate, the shear mark was not able to be removed completely.

Note that a high-speed camera was used to take images of the process from the end of the formation of a molten glass gob 24 until the completion of press-molding. As a result, it was found that the molten glass gob 24 turned insufficiently, and hence press started before a separation mark 24A faced a press-molding surface.

### Comparative Example 2

A molten glass gob was separated by using cross-type shear blades as in Example 1. Note that each glass blank was manufactured in the same manner as that in Example 1 except that press-molding was carried out in a state in which the movement direction of a pair of shear blades and the movement direction of a pair of press molds were significantly differentiated from each other instead of a substantially parallel state. The surface of each resultant glass blank was observed to find that a shear mark was formed in a peripheral portion away from the center of the glass blank. Thus, the shear mark was not able to be removed by carrying out only a central hole-forming step.

Note that a high-speed camera was used to take images of the process from the end of the formation of a molten glass gob 24 until the completion of press-molding. As a result, it was found that press started in a state in which a separation mark did not face a molding surface at all.

### Comparative Example 3

Each glass blank was manufactured in the same manner as that in Example 1 except that the falling distance was changed to 100 mm. The surface of each resultant glass blank was observed to find that a shear mark was formed in a peripheral portion away from the center of the glass blank. Thus, the shear mark was not able to be removed by carrying out only a central hole-forming step.

Note that a high-speed camera was used to take images of the process from the end of the formation of a molten glass gob 24 until the completion of press-molding. As a result, it was found that press started under a state in which a separation mark did not face a molding surface at all.

### Comparative Example 4

Each glass blank was manufactured in the same manner as that in Example 1 except that the driving timing of shear blades 30 and 40 and the driving timing of press molds 50 and 60 were differentiated from each other. The surface of each resultant glass blank was observed to find that a shear mark was formed in a peripheral portion away from the center of the glass blank. Thus, the shear mark was not able to be removed by carrying out only a central hole-forming step.

Note that a high-speed camera was used to take images of the process from the end of the formation of a molten glass gob 24 until the completion of press-molding. As a result, it was found that press started under a state in which a separation mark did not face a molding surface at all.

### Example 2

Each glass blank was manufactured in the same manner as that in Example 1 except that the shape of the aperture of a glass outlet 12 was changed to a slightly larger one compared with the shape in Example 1 by adopting an elliptical shape having a major axis of 30 mm and a minor axis of 10 mm as the shape of the aperture. The surfaces of each resultant glass blank were observed to find that a shear mark was present in the center of the glass blank, but part of the shear mark was present out of the area of the central hole formed in a central hole-forming step. Thus, the shear mark was not able to be removed completely by carrying out only the central hole-forming step. However, the shear mark was able to be removed completely by carrying out a lapping step. Note that the grinding amount in the lapping step was as very small as 30 μm compared with 50 μm in Comparative Example 1.

Note that a high-speed camera was used to take images of the process from the end of the formation of a molten glass gob 24 until the completion of press-molding. As a result, it was confirmed that the molten glass gob 24 turned by 90° during falling, and a separation mark 24A which had been positioned in an upper surface of the molten glass gob 24 immediately after its separation with a pair of shear blades 30 and 40 contacted a molding surface 62A earlier than any of the portions of the surface of the molten glass gob 24 at the time of the start of press-molding exemplified in FIG. 7.

### <Examples of Second Aspect of Present Invention>

Hereinafter, the second aspect of the present invention is described in more details based on examples, but the second aspect of the present invention is not limited to the following examples.

### Example 1

Materials such as oxides, carbonates, nitrates, and hydroxides were weighed and mixed enough, yielding each blended material, so that glass having each of the compositions listed in Table 2 is obtained. The blended material was fed into a melting tank in a glass melting furnace, was heated, and was melt. The resultant molten glass was transferred from the melting tank to a fining tank, and bubbles were removed in the fining tank. Further, the molten glass was transferred to an operation tank, was stirred and homogenized in the operation tank, and was caused to flow out from a glass effluent pipe provided in the bottom portion of the operation tank. The melting tank, the fining tank, the operation tank, and the glass effluent pipe were each under temperature control, and the temperature and viscosity of the glass are each kept in an optimal state in each step. The molten glass flowing out from the glass effluent pipe was cast into a mold. The resultant glass was used as a sample to measure its glass transition temperature and liquidus temperature. A method of measuring a glass transition temperature and a method of measuring a liquidus temperature are mentioned below.

### (1) Glass Transition Temperature Tg

The glass transition temperature Tg of each glass was measured by using a thermomechanical analyzer (TMA).

### (2) Liquidus Temperature

A glass sample was put in a platinum crucible and kept at a predetermined temperature for 2 hours. After being taken out from the furnace, the glass sample was cooled and the presence or absence of crystal precipitation was observed with a microscope. The lowest temperature at which crystals are not observed was defined as a liquidus temperature (L. T.).

Table 2 shows the glass transition temperature and liquidus temperature of each glass.

TABLE 2

| | | No. 1 | No. 2 | No. 3 | No. 4 | No. 5 | No. 6 |
|---|---|---|---|---|---|---|---|
| Glass | SiO₂ | 66 | 68 | 61 | 64 | 66 | 64 |
| composition | Al₂O₃ | 9 | 9 | 2 | 5 | 0.5 | 5 |
| | Li₂O | 12 | 8 | 14 | 4 | 0 | 1.5 |
| | Na₂O | 10 | 11 | 5 | 6 | 3 | 8.5 |
| | K₂O | 0 | 0.2 | 0 | 1 | 6 | 0 |
| | Li₂O + Na₂O + K₂O | 22 | 19.2 | 19 | 11 | 9 | 10 |
| | MgO | 0 | 1 | 0 | 0 | 6.5 | 4 |
| | CaO | 0 | 1.8 | 13 | 13 | 13 | 13 |
| | SrO | 0 | 0 | 0 | 0 | 0 | 0 |
| | BaO | 0 | 0 | 0 | 3 | 0 | 0 |
| | ZnO | 0 | 0 | 0 | 0 | 0 | 0 |
| | MgO + CaO + SrO + BaO + ZnO | 0 | 2.8 | 13 | 16 | 19.5 | 17 |
| | ZrO₂ | 3 | 1 | 5 | 4 | 5 | 4 |
| | TiO₂ | 0 | 0 | 0 | 0 | 0 | 0 |
| | La₂O₃ | 0 | 0 | 0 | 0 | 0 | 0 |
| | Y₂O₃ | 0 | 0 | 0 | 0 | 0 | 0 |
| | Yb₂O₃ | 0 | 0 | 0 | 0 | 0 | 0 |
| | Ta₂O₅ | 0 | 0 | 0 | 0 | 0 | 0 |
| | Nb₂O₅ | 0 | 0 | 0 | 0 | 0 | 0 |
| | HfO₂ | 0 | 0 | 0 | 0 | 0 | 0 |
| | ZrO₂ + TiO₂ + La₂O₃ + Y₂O₃ + | 3 | 1 | 5 | 4 | 5 | 4 |
| | Ta₂O₅ + Nb₂O₅ + HfO₂ | | | | | | |
| | Total (mol %) | 100 | 100 | 100 | 100 | 100 | 100 |
| | SnO₂ (mass %, outer | 0.6 | 0.6 | 0.6 | 0.6 | 0.6 | 0.6 |
| | percentage) | | | | | | |
| | CeO₂ (mass %, outer | 0.4 | 0.4 | 0.4 | 0.4 | 0.4 | 0.4 |
| | percentage) | | | | | | |
| | SnO₂ + CeO₂ | 1.0 | 1.0 | 1.0 | 1.0 | 1.0 | 1.0 |
| | (mass %, outer percentage) | | | | | | |
| | SnO₂/(SnO₂ + CeO₂) | 0.6 | 0.6 | 0.6 | 0.6 | 0.6 | 0.6 |
| | (mass ratio) | | | | | | |
| Properties | Viscosity (dPa · s) of glass | 650 | 1000 | 50 | 850 | 1050 | 1000 |
| | at 1250° C. | | | | | | |
| | Liquidus temperature (° C.) | 840 | 920 | 1000 | 1080 | 1180 | 1210 |
| | Glass transition | 500 | 505 | 535 | 665 | 700 | 633 |
| | temperature (° C.) | | | | | | |

The each glass was used and each glass blank was manufactured sequentially. The each glass blank was manufactured by the method illustrated in FIG. 13 to FIG. 22. In this case, the viscosity of a molten glass flow was adjusted so as to be constant in the range of 500 to 1,050 dPa·s.

An elliptical shape having a major axis of 28 mm and a minor axis of 8 mm was adopted as the shape of a glass outlet. Cutting of the molten glass flow was performed by shearing a falling molten glass flow in the direction parallel to the major axis of the glass outlet with a pair of V-shaped shear blades. Further, press mold bodies 5-1 and 6-1 and guide members 5-2 and 6-2 were made of cast iron (FCD).

The height of each press mold was adjusted so that the falling distance from the position at which the molten glass gob was separated to the position at which the molten glass gob started be pressed was controlled to 200 mm or less. The time required from the start of press until mold closing was controlled to 0.1 second or less and press pressure was set to about 6.7 MPa. Subsequently, the pressure was reduced, and while both the press-molding surfaces were closely attached to glass, the glass was cooled for several seconds. Next, the press pressure was released and the press molds were detached from each other, to thereby release and take out a glass blank. Note that, in the above-mentioned series of steps, temperature rise may be suppressed by cooling the press molds by using a cooling medium.

The diameter, circularity, thickness, thickness deviation, and flatness of each resultant glass blank were measured by using a three-dimensional measuring machine and a micrometer. As a result, the diameter was 75 mm, the circularity was within ±0.5 mm, the thickness was 0.90 mm, the thickness deviation was 10 μm or less, and the flatness was 4 μm or less. Note that the diameter/thickness ratio is determined to be 83.3 based on the above-mentioned measurement results.

The main surfaces of the each resultant glass blank were observed to find a trace of a shear mark in the central portion of one of the main surfaces. The shear mark is localized in a circle with a radius of 5 mm at the center of each glass blank, and the shear mark is removed completely when a central hole with an inner diameter of 20 mm was formed. The glass blank is annealed to reduce or remove strain.

### Example 2

The glass blank manufactured in Example 1 was used to apply scribe processing on a portion serving as an outer periphery of a magnetic disk substrate and a portion serving as a central hole thereof. As a result of the processing, two grooves looking like concentric circles are formed outside and inside. Next, by partially heating the portions in which the scribe processing was applied, cracks were caused to occur along the each groove produced by the scribe processing, by virtue of the difference in thermal expansion of glass, and the outside portion and inside portion of the outer concentric circle are removed. As a result, a disk-shaped glass having a perfect circle shape and a ring shape is obtained, and the processing completely removes a trace of a shear mark.

Next, shape processing was applied to the disk-shaped glass by using chamfering or the like and its end surfaces were polished. Then, after a first polishing is carried out on the main surfaces of the disk-shaped glass, the glass is immersed in a chemical strengthening solution to perform chemical strengthening.

After the chemical strengthening, the glass was sufficiently cleaned and then subjected to a second polishing. After the second polishing process, the disk-shaped glass was cleaned again and a glass substrate for a magnetic disk was manufactured. The substrate had an outer diameter of 65 mm, a central hole diameter of 20 mm, a thickness of 0.8 mm, a main surface flatness of 4 μm or less, and a main surface roughness of 0.2 nm or less. Thus, a magnetic recording medium substrate having a desired shape was able to be obtained without carrying out the lapping step.

### Example 3

On both main surfaces of the magnetic recording medium substrate (glass substrate for magnetic disk) manufactured in Example 2, an inline-type sputtering apparatus was used to form sequentially a CrTi adherent layer, a CoTaZr/Ru/CoTaZr soft magnetic layer, a CoCrSiO₂ non-magnetic granular undercoat layer, a CoCrPt—SiO₂.TiO₂ magnetic granular layer, and a hydrogenated carbon protective layer, and then, a perfluoropolyether lubricant layer was formed on the uppermost layer by a dip method, yielding a magnetic recording medium (magnetic disk). The thus obtained magnetic disk was incorporated into a hard disk drive, and its movement was checked to find that the magnetic disk had desired performance.

What is claimed is:

1. A method of manufacturing a glass blank, comprising at least :
forming a molten glass gob by separating a forward end portion of a molten glass flow flowing out continuously; and
after the forming of the molten glass gob, press-molding the molten glass gob dropping down with a first press mold and a second press mold arranged facing each other in a direction crossing a direction in which the molten glass gob drops down,
wherein:
the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface; and
one sheet of the glass blank is used for production of one sheet of a magnetic recording medium substrate having a central hole.

2. A method of manufacturing a glass blank according to claim 1,
wherein:
the forming of the molten glass gob is carried out by separating a forward end portion of a molten glass flow flowing out continuously toward a vertical downward direction; and
the press-molding includes carrying out applying an external force to at least one glass material to be press-molded selected from:
(1) the forward end portion of the molten glass flow to be separated as the molten glass gob during the forming of the molten glass gob; and
(2) the molten glass gob dropping down in a period just after completion of the forming of the molten glass gob to just before start of the press-molding,
from a direction crossing a vertical direction so that a vector sum of forces acting in a direction perpendicular to a central axis of the glass material to be press-molded parallel to the vertical direction substantially exceeds 0, in order to rotate the molten glass gob so that the molten glass gob can be brought into contact with at least one molding surface selected from the molding surface of the first press mold and the molding surface of the second press mold facing a separation mark, which is formed on an upper surface of the molten glass gob during the separating of the forward end portion of the molten glass flow, under a state in which the separation mark faces the at least one molding surface.

3. A method of manufacturing a glass blank according to claim 2,
wherein:
a cross-section near the forward end portion of the molten glass flow in a plane surface perpendicular to a direction in which the molten glass flow drops down has a substantially elliptical shape having a major axis and a minor axis; and
the separating of the forward end portion of the molten glass flow is carried out by allowing a pair of shear blades to penetrate the molten glass flow from a direction substantially perpendicular to the direction in which the molten glass flow drops down and substantially identical to a major axis direction of the cross-section near the forward end portion of the molten glass flow and from a direction opposite each other and crossing a vertical direction.

4. A method of manufacturing a glass blank according to claim 2,
wherein:
the separating of the forward end portion of the molten glass flow is carried out by allowing a pair of shear blades to penetrate the molten glass flow from a direction substantially perpendicular to a direction in which the molten glass flow drops down and from a direction opposite each other and crossing a vertical direction; and
a cutting portion of each of the pair of shear blades is branched and has any one shape selected from a V-shape and a U-shape.

5. A method of manufacturing a glass blank according to claim 3,
wherein:
the separating of the forward end portion of the molten glass flow is carried out by allowing the pair of shear blades to penetrate the molten glass flow from a direction substantially perpendicular to the direction in which the molten glass flow drops down and from a direction opposite each other and crossing the vertical direction; and
a cutting portion of each of the pair of shear blades is branched and has any one shape selected from a V-shape and a U-shape.

6. A method of manufacturing a glass blank according to claim 1,
wherein
the separation mark, which is present on the surface of the molten glass gob just before carrying out the press-molding, is positioned on a straight line connecting a central point of the molten glass gob to any one molding surface selected from the molding surface of the first press mold and the molding surface of the second press mold in a shortest distance.

7. A method of manufacturing a glass blank according to claim 2,
wherein
the separation mark, which is present on the surface of the molten glass gob just before carrying out the press-molding, is positioned on a straight line connecting a central point of the molten glass gob to any one molding surface selected from the molding surface of the first press mold and the molding surface of the second press mold in a shortest distance.

8. A method of manufacturing a glass blank according to claim 3,
wherein
the separation mark, which is present on the surface of the molten glass gob just before carrying out the press-molding, is positioned on a straight line connecting a central point of the molten glass gob to any one molding surface selected from the molding surface the first press mold and the molding surface of the second press mold in a shortest distance.

9. A method of manufacturing a glass blank according to claim 4,
wherein
the separation mark, which is present on the surface of the molten glass gob just before carrying out the press-molding, is positioned on a straight line connecting a central point of the molten glass gob to any one molding surface selected from the molding surface of the first press mold and the molding surface of the second press mold in a shortest distance.

10. A method of manufacturing a glass blank according to claim 5,
wherein
the separation mark, which is present on the surface of the molten glass gob just before carrying out the press-molding, is positioned on a straight line connecting a central point of the molten glass gob to any one molding surface selected from the molding surface of the first press mold and the molding surface of the second press mold in a shortest distance.

11. A method of manufacturing a glass blank according to claim 1,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

12. A method of manufacturing a glass blank according to claim 2,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

13. A method of manufacturing a glass blank according to claim 3,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

14. A method of manufacturing a glass blank according to claim 4,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

15. A method of manufacturing a glass blank according to claim 5,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

16. A method of manufacturing a glass blank according to claim 6,
wherein
the press-molding is carried out so that the molten glass gob is completely extended by pressure between the molding surface of the first press mold and the molding surface of the second press mold and is molded into a flat glass, in which
at least a region in contact with the flat glass in each of the molding surface of the first press mold and the molding surface of the second press mold forms a flat surface.

17. A method of manufacturing a magnetic recording medium substrate, comprising:
manufacturing a glass blank, including at least:
forming a molten glass gob by separating a forward end portion of a molten glass flow flowing out continuously; and
after the forming of the molten glass gob, press-molding the molten glass gob dropping down with a first press mold and a second press mold arranged facing each other in a direction crossing a direction in which the molten glass gob drops down; and then
manufacturing one sheet of a magnetic recording medium substrate from one sheet of the glass blank, including at least:
forming a central hole at a central portion of a main surface of the glass blank; and
polishing the main surface,
wherein
the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface.

18. A method of manufacturing a magnetic recording medium, comprising:
manufacturing a glass blank, including at least:
forming a molten glass gob by separating a forward end portion of a molten glass flow flowing out continuously; and
after the forming molten glass gob, press-molding the molten glass gob dropping down with a first press mold and a second press mold arranged facing each other in a direction crossing a direction in which the molten glass gob drops down;
manufacturing one sheet of a magnetic recording medium substrate from one sheet of the glass blank, including at least:
forming a central hole at a central portion of a main surface of the glass blank; and
polishing the main surface; and then
manufacturing a magnetic recording medium, including at least
forming a magnetic recording layer on a main surface of the magnetic recording medium substrate,
wherein
the press-molding is carried out so that the molten glass gob is brought into contact with at least one molding surface selected from a molding surface of the first press mold and a molding surface of the second press mold facing a separation mark, which is formed on a surface of the molten glass gob during the separating of the forward end portion of the molten glass flow, under a state in which the separation mark faces the at least one molding surface.
